(19) United States
(12) Patent Application Publication
(10) Pub. No.: US 2025/0031211 A1
(43) Pub. Date: Jan. 23, 2025

(54) METHOD AND DEVICE IN NODES USED FOR WIRELESS COMMUNICATION

(71) Applicants: Lu WU, Shanghai (CN); Shengnan XU, Shanghai (CN); Xiaobo ZHANG, Shanghai (CN)

(72) Inventors: Lu WU, Shanghai (CN); Shengnan XU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/777,555

(22) Filed: Jul. 19, 2024

(30) Foreign Application Priority Data
Jul. 21, 2023 (CN) 202310909856.X

(51) Int. Cl. H04W 72/23; H04L 5/00

(52) U.S. Cl. CPC H04W 72/23; H04L 5/0048

(57) ABSTRACT

The present application provides a method and device in a node for wireless communications. A first receiver receives a second information block; receives a first information block, the first information block is used to determine a reference time-domain resource set; monitors at least a first PDCCH candidate in the first search space set and at least a second PDCCH candidate in the second search space set; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain. The present application reduces interference and improves transmission quality.

### CROSS REFERENCE TO RELATED APPLICATIONS

The present application claims the priority benefit of Chinese Patent Application No.202310909856.X, filed on July 21,2023, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

In existing NR (New Radio) systems, spectrum resources are divided into FDD (Frequency Division Duplexing) spectrum and TDD (Time Division Duplexing) spectrum. For the TDD spectrum, both the base station and User Equipment (UE) operate in half-duplex mode. This half-duplex mode avoids self-interference and can mitigate the impact of Cross Link interference, but also brings about a decrease in resource utilization and an increase in latency. For these problems, supporting flexible duplex mode or variable link orientation (uplink or downlink or flexible) on the TDD spectrum or FDD spectrum becomes a possible solution. In 3GPP (3rd Generation Partner Project) RAN (Radio Access Network) #88e meeting and in 3GPP R (Release)-18 workshop, the support of more flexible duplex modes or full-duplex modes in NR R-18 has received a lot of attention and discussion, especially the subband non-overlapping full-duplex (SBFD) mode at the gNB (NR node B) end. In this mode, the same symbol is used in part of frequency resources for uplink and in another part of frequency resources for downlink, so the resource utilization is improved and the delay is reduced.

### SUMMARY

Inventors have found through researches that how to receive a PDCCH (Physical Downlink Control Channel) candidates in the two linked search space sets is a key issue.

To address the above problem, the present application provides a solution. It should be noted that in the description of the present application, only more flexible duplex mode, full duplex mode, and SBFD mode are used as examples. The present application can also be applied to other duplex mode scenarios. Furthermore, adopting a unified design scheme for different scenarios (including but not limited to more flexible duplex mode, full duplex mode, SBFD mode, half duplex mode, traditional duplex mode, network energy-saving mode, non-energy-saving mode, etc.) can also help reduce hardware complexity and cost. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a second information block, the second information block being used to determine that a first search space set and a second search space set are linked;
receiving a first information block, the first information block being used to determine a reference time-domain resource set; and
monitoring at least a first PDCCH candidate in the first search space set and at least a second PDCCH candidate in the second search space set;
herein, the first PDCCH candidate and the second PDCCH candidate are monitored for detecting a DCI (Downlink Control Information) format with same information; at least one of QCL (quasi co-location) information of a DMRS (Demodulation Reference Signal) antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, a problem to be solved in the present application comprises: in a system configured with a reference time-domain resource set, how to determine QCL information of a DMRS antenna port for a PDCCH reception on a PDCCH candidate in two linked search space sets. In the above method, in the two linked search space sets, QCL information of a DMRS antenna port for a PDCCH reception on a PDCCH candidate depends on the reference time-domain resource set, solving this problem.

In one embodiment, advantages of the above method comprise: improving the reliability of receiving PDCCH candidates and enhancing the system performance.

In one embodiment, advantages of the above method comprise: reducing the interference of receiving PDCCH candidates in different types of symbols.

In one embodiment, advantages of the above method comprise: providing more appropriate QCL information and ensuring reception performance.

According to one aspect of the present application, it is characterized in that when both the first PDCCH candidate and the second PDCCH candidate are orthogonal to the reference time-domain resource set in time domain, the DMRS antenna port for the PDCCH reception on the first PDCCH candidate and a first RS (Reference Signal) resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, advantages of the above method comprise: a DMRS antenna port for a PDCCH reception on different PDCCH candidates are quasi co-located with different RS resources, which improves the effectiveness of PDCCH reception.

In one embodiment, advantages of the above method comprise: according to whether a PDCCH candidate is orthogonal to the reference time-domain resources in time domain, its quasi co-located RS resources are determined, which reduces the link interference and improves the transmission reliability.

According to one aspect of the present application, the feature is that a first CORESET (Control Resource Set) is associated with the first search space set, and a second CORESET is associated with the second search space set; a target time-domain resource set comprises time-domain resources outside the reference time-domain resource set; in the target time-domain resource set, a DMRS antenna port for a PDCCH reception and a first RS resource are quasi co-located in the first CORESET, while a DMRS antenna port for a PDCCH reception and a second RS resource are quasi co-located in the second CORESET; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

In one embodiment, advantages of the above method comprise: in a target time-domain resource set and a reference time-domain resource set, a DMRS antenna port for a PDCCH reception is co-located with different RS resources in a CORESET, reducing link interference between different users.

According to one aspect of the present application, it is characterized in that when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, advantages of the above method comprise: according to whether the first PDCCH candidate and the second PDCCH candidate belong to a same type of symbol or resources in time domain, its quasi co-located RS resources are determined, which improves the flexibility of system design.

According to one aspect of the present application, comprising:
receiving a third information block;
herein, the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource.

In one embodiment, advantages of the above method comprise: the configuration information of the first CORESET and the configuration information of the second CORESET are respectively used to determine at least one RS resource, so that RS resources can be flexibly selected according to demands.

In one embodiment, advantages of the above method comprise: increasing flexibility of configuration.

According to one aspect of the present application, it is characterized in that a first CORESET is associated with the first search space set, and a second CORESET is associated with the second search space set; the first CORESET is configured with only one TCI (Transmission Configuration Indicator) state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource.

According to one aspect of the present application, it is characterized in that a first CORESET is associated with the first search space set, and a second CORESET is associated with the second search space set; the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

In one embodiment, advantages of the above method comprise: one of the first CORESET and the second CORESET is configured with only one TCI state, signaling overhead is saved while certain performance is ensured.

According to one aspect of the present application, the feature is that the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameters in the reference time-domain resource set are used for uplink transmission.

According to one aspect of the present application, the feature is that there exist two PDCCH candidates respectively on two types of symbols in the first search space set, there exist two PDCCH candidates respectively on two types of symbols in the second search space set, and the reference time-domain resource set comprises only one type of symbols between the two types of symbols.

In one embodiment, advantages of the above method comprise: supporting simultaneous uplink and downlink transmission on a same symbol reduces latency and improves resource utilization.

The present application provides a method in a second node for wireless communications, comprising:
transmitting a second information block, the second information block being used to determine that a first search space set and a second search space set are linked; and
transmitting a first information block, the first information block being used to determine a reference time-domain resource set;
herein, a receiver of the second information block monitors at least a first PDCCH candidate in the first search space set and at least a second PDCCH candidate in the second search space set; the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

According to one aspect of the present application, it is characterized in that when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

According to one aspect of the present application, it is characterized in that the first CORESET is associated with the first search space set, and the second CORESET is associated with the second search space set; a target time-domain resource set comprises time-domain resources outside the reference time-domain resource set; in the target time-domain resource set, a DMRS antenna port for a PDCCH reception and a first RS resource are quasi co-located in the first CORESET, while a DMRS antenna port for a PDCCH reception and a second RS resource are quasi co-located in the second CORESET; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

According to one aspect of the present application, it is characterized in that when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

According to one aspect of the present application, comprising:
transmitting a third information block;
herein, the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource.

According to one aspect of the present application, it is characterized in that a first CORESET is associated with the first search space set, and a second CORESET is associated with the second search space set; the first CORESET is configured with only one TCI state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource;

According to one aspect of the present application, it is characterized in that a first CORESET is associated with the first search space set, and a second CORESET is associated with the second search space set; the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

According to one aspect of the present application, the feature is that the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameters in the reference time-domain resource set are used for uplink transmission.

According to one aspect of the present application, the feature is that there exist two PDCCH candidates respectively on two types of symbols in the first search space set, there exist two PDCCH candidates respectively on two types of symbols in the second search space set, and the reference time-domain resource set comprises only one type of symbols between the two types of symbols.

The present application provides a first node for wireless communications, comprising:
a first receiver, receiving a second information block, the second information block being used to determine that a first search space set and a second search space set are linked;
the first receiver, receiving a first information block, the first information block being used to determine a reference time-domain resource set; and
the first receiver, monitoring at least a first PDCCH candidate in the first search space set and at least a second PDCCH candidate in the second search space set;
herein, the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

The present application provides a second node for wireless communications, comprising:
a second transmitter, transmitting a second information block, the second information block being used to determine that a first search space set and a second search space set are linked; and
the second transmitter, transmitting a first information block, the first information block being used to determine a reference time-domain resource set;
herein, a receiver of the second information block monitors at least a first PDCCH candidate in the first search space set and at least a second PDCCH candidate in the second search space set; the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, the present application has the following advantages over conventional schemes:
improving the reliability of receiving PDCCH candidates and enhancing the system performance; saving the signaling overhead;
improving the flexibility of the system;
reducing interference and improving the transmission reliability.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block and a second information block according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of wireless communications according to one embodiment of the present application;

FIG. 6 illustrates a schematic diagram of RS resources quasi co-located with a DMRS antenna port for a PDCCH reception on a first PDCCH candidate and RS resources quasi co-located with a DMRS antenna port for a PDCCH reception on a second PDCCH candidate according to one embodiment of the present application;

FIG. 7 illustrates a schematic diagram of a target time-domain resource set and a reference time-domain resource set according to one embodiment of the present application;

FIG. 8 illustrates a schematic diagram of RS resources quasi co-located with a DMRS antenna port for a PDCCH reception on a first PDCCH candidate and RS resources quasi co-located with a DMRS antenna port for a PDCCH reception on a second PDCCH candidate according to another embodiment of the present application;

FIG. 9 illustrates a schematic diagram of a third information block according to one embodiment of the present application;

FIGS. 10A-10B respectively illustrate schematic diagrams of a first CORESET configured with only one TCI state or a second CORESET configured with only one TCI state according to one embodiment of the present application;

FIGS. 11A-11B respectively illustrate schematic diagrams of a reference time-domain resource set and two types of symbols according to one embodiment of the present application;

FIG. 12 illustrates a structure block diagram of a processor in a first node according to one embodiment of the present application;

FIG. 13 illustrates a structure block diagram of a processor in a second node according to one embodiment of the present application.

### DESCRIPTION OF THE EMBODIMENTS

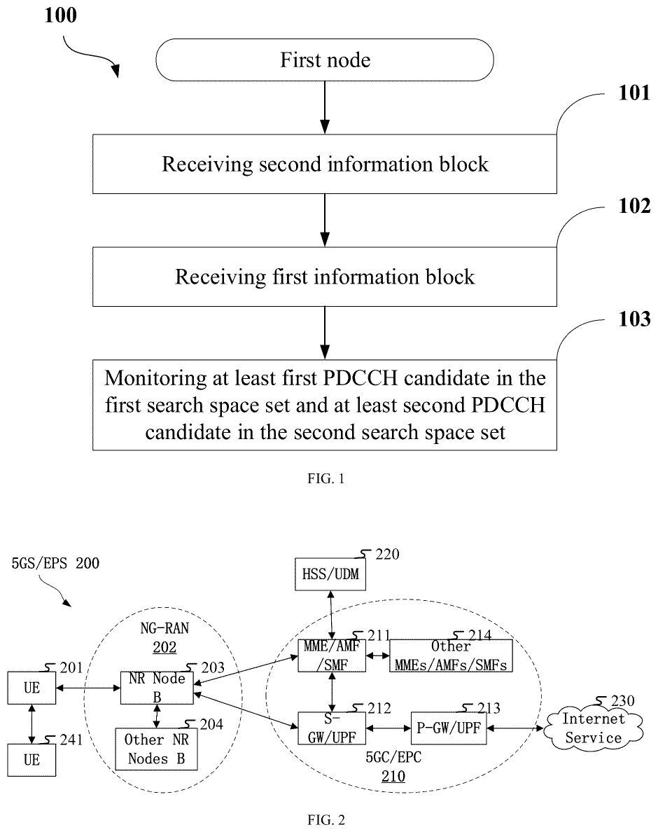

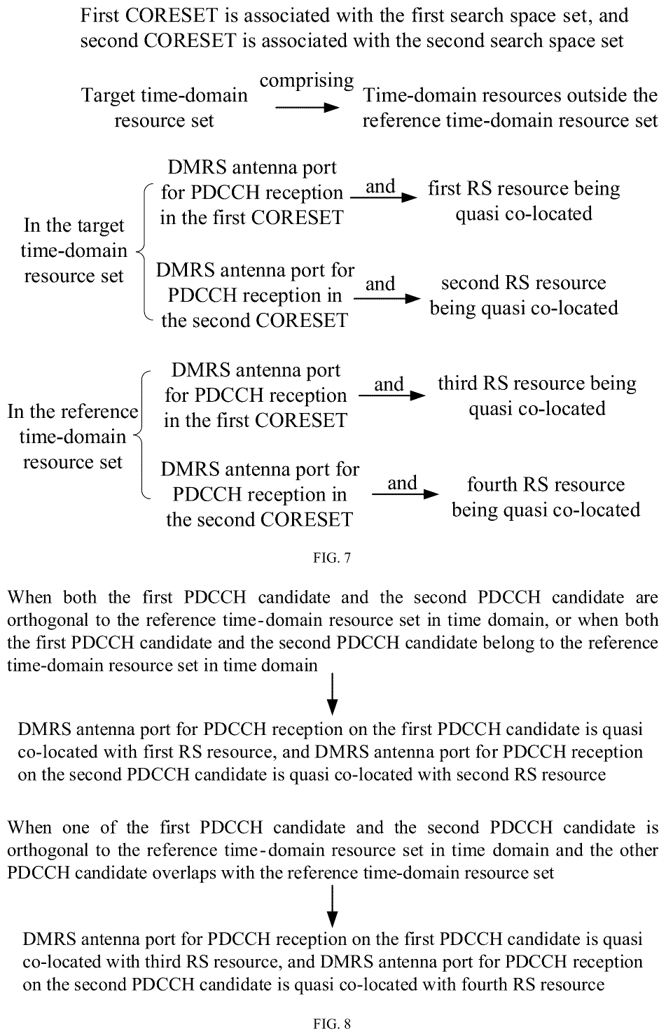

The technical scheme of the present application is described below in further details in conjunction with the drawings. It should be noted that the embodiments of the present application and the characteristics of the embodiments may be arbitrarily combined if no conflict is caused. Based on considerations of flexibility, complexity; overhead, and compatibility; the person skilled in the art is motivated to flexibly combine embodiments in different figures without contradicting each other, such as (but not limited to) embodiments in FIG. 1 and embodiments in FIGS. 5-11B, embodiments in FIG. 5 and embodiments in FIGS. 6-11B, and so forth.

### Embodiment 1

Embodiment 1 illustrates a flowchart of a first information block and a second information block according to one embodiment of the present application, as shown in FIG. 1. In step 100 illustrated by FIG. 1, each box represents a step. In particular, the order of steps in boxes does not represent chronological order of characteristics between the steps.

In embodiment 1, the first node in the present application receives a second information block in step 101, and the second information block is used to determine that a first search space set and a second search space set are linked; receives a first information block in step 102, the first information block is used to determine a reference time-domain resource set; monitors at least a first PDCCH candidate in the first search space set and at least a second PDCCH candidate in the second search space set in step 103; herein, the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, the second information block is carried by a higher-layer signaling.

In one embodiment, the second information block is carried by an RRC (Radio Resource Control) signaling.

In one embodiment, the second information block comprises information in all or partial fields in an RRC IE (Information Element).

In one embodiment, the second information block comprises information in all or partial fields in each RRC IE in multiple RRC IEs.

In one embodiment, the second information block comprises information in all or partial fields in an RRC IE whose name comprises “SearchSpace”.

In one embodiment, the second information block comprises information in all or partial fields in a SearchSpace IE.

In one embodiment, the second information block comprises information in all or partial fields in each SearchSpace IE in multiple SearchSpace IEs.

In one embodiment, the second information block comprises information in all or partial fields in each SearchSpace IE in two SearchSpace IEs.

In one embodiment, the second information block comprises a field in a SearchSpace IE whose name comprises “searchSpaceLinking”.

In one embodiment, the second information block comprises a searchSpaceLinkingId field in a SearchSpace IE.

In one embodiment, the second information block comprises a field in each SearchSpace IE whose name comprises “searchSpaceLinking” in multiple SearchSpace IEs.

In one embodiment, the second information comprises a searchSpaceLinkingId field in each SearchSpace IE in multiple SearchSpace IEs.

In one embodiment, a searchSpaceLinkingId field in each SearchSpace IE of multiple SearchSpace IEs comprised in the second information block has a same value.

In one embodiment, the second information block comprises a field in each SearchSpace IE whose name comprises “searchSpaceLinking” in two SearchSpace IEs.

In one embodiment, the second information comprises a searchSpaceLinkingId field in each SearchSpace IE in two SearchSpace IEs.

In one embodiment, a searchSpaceLinkingId field in each SearchSpace IE of two SearchSpace IEs comprised in the second information block has a same value.

In one embodiment, the second information block comprises one or multiple RRC IEs. In one embodiment, the second information block comprises one or more SearchSpace IEs.

In one embodiment, the second information block comprises multiple SearchSpace IEs.

In one embodiment, the second information block comprises two SearchSpace IEs.

In one embodiment, each SearchSpace IE in two SearchSpace IEs comprised in the second information block comprises a searchSpaceLinkingId field.

In one embodiment, each SearchSpace IE in two SearchSpace IEs comprised in the second information block comprises a searchSpaceLinkingId field, and a value of each searchSpaceLinkingId field is the same.

In one embodiment, for the specific meanings of SearchSpace IE and searchSpaceLinkingId field, refer to chapter 6.3.2 in 3GPP TS 38.331.

In one embodiment, the second information block comprises configuration information of the first search space set and configuration information of the second search space set.

In one embodiment, the second information block comprises two RRC IEs, and the two RRC IEs respectively comprise configuration information of the first search space set and configuration information of the second search space set.

In one embodiment, the second information block comprises two SearchSpace IEs, and the two SearchSpace IEs respectively comprise configuration information of the first search space set and configuration information of the second search space set.

In one embodiment, configuration information of a search space set comprises: search space set index, index of associated CORESET, periodicity and offset of PDCCH monitoring, PDCCH monitoring pattern within a slot, number of slots present in search space set or number of slots in consecutive slot groups, a bitmap indicating a slot in a slot group used for PDCCH monitoring, a number of PDCCH candidates at an aggregation level for each CCE (Control Channel Element), an indication of search space type, and an indication of being linked to another search space set.

In one embodiment, the configuration information of the search space set can be found in chapter 10.1 of 3GPP TS 38.213.

In one embodiment, a searchSpaceId field in a SearchSpace IE comprised in the second information block configures a search space set index.

In one embodiment, a controlResourceSetId field in a SearchSpace IE comprised in the second information configures an index of an associated CORESET.

In one embodiment, a monitoringSlotPeriodicity AndOffset field in a SearchSpace IE comprised in the second information block configures a period and offset of PDCCH monitoring.

In one embodiment, a monitoringSymbolsWithinSlot field in a SearchSpace IE comprised in the second information block configures a PDCCH monitoring mode within a slot.

In one embodiment, a duration field in a SearchSpace IE comprised in the second information block configures a number of slot(s) present in a search space set or a number of slot(s) within consecutive slot group(s).

In one embodiment, a monitoring Slots WithinSlotGroup field in a SearchSpace IE comprised in the second information block configures a bitmap indicating a slot in a slot group used for PDCCH monitoring.

In one embodiment, a nrofCandidates field in a SearchSpace IE comprised in the second information block configures a number of PDCCH candidate(s) of each CCE aggregation level.

In one embodiment, a searchSpaceType field in a SearchSpace IE comprised in the second information block configures a search space type indication.

In one embodiment, a searchSpaceLinkingId field in a SearchSpace IE comprised in the second information block configures an indication of being linked to another search space set.

In one embodiment, configuration information of the first search space set comprises part or all of configuration information of the search space set.

In one embodiment, configuration information of the first search space set at least comprises a search space set index in configuration information of the search space set.

In one embodiment, configuration information of the first search space set at least comprises an indication of being linked to another search space set in configuration information of the search space set.

In one embodiment, configuration information of the first search space set at least comprises an index of a search space set in configuration information of the search space set and an indication of being linked to another search space set.

In one embodiment, configuration information of the first search space set at least comprises an index of a search space set in configuration information of the search space set and an index of associated CORESET.

In one embodiment, configuration information of the first search space set at least comprises an index of a search space set in configuration information of the search space set, an index of an associated CORESET, and an indication of being linked to another search space set.

In one embodiment, configuration information of the second search space set comprises part or all of configuration information of the search space set.

In one embodiment, configuration information of the second search space set at least comprises a search space set index in configuration information of the search space set.

In one embodiment, configuration information of the second search space set at least comprises an indication of being linked to another search space set in configuration information of the search space set.

In one embodiment, configuration information of the second search space set at least comprises an index of a search space set in configuration information of the search space set and an indication of being linked to another search space set.

In one embodiment, configuration information of the second search space set at least comprises an index of a search space set in configuration information of the search space set and an index of associated CORESET.

In one embodiment, configuration information of the second search space set at least comprises an index of a search space set in configuration information of the search space set, an index of an associated CORESET, and an indication of being linked to another search space set.

In one embodiment, an indication of being linked with another search space set in configuration information of the search space set comprises a searchSpaceLinkingId field.

In one embodiment, an indication of being linked with another search space set in configuration information of the search space set is a searchSpaceLinkingId field.

In one embodiment, an indication of being linked with another search space set in configuration information of the search space set is carried by a searchSpaceLinkingId field.

In one embodiment, “the first search space set and the second search space set being linked” comprises: configuration information of the first search space set comprises at least one first-type parameter, and configuration information of the second search space set comprises at least one first-type parameter, a first-type parameter in the configuration information of the first search space set and a first-type parameter in the configuration information of the second search space set have a same value.

In one subembodiment of the above embodiment, the first-type parameter comprises an indication of being linked to another search space set in configuration information of the search space set.

In one subembodiment of the above embodiment, the first-type parameter comprises a searchSpaceLinkingId field.

In one subembodiment of the above embodiment, the first-type parameter is a searchSpaceLinkingId field.

In one subembodiment of the above embodiment, a value of the first-type parameter is an integer.

In one subembodiment of the above embodiment, a value of the first-type parameter is a non-negative integer.

In one embodiment, “the first search space set and the second search space set being linked” comprises: a PDCCH candidate in the first search space set and a PDCCH candidate in the second search space set are monitored for detecting a DCI format with same information.

In one embodiment, “the first search space set and the second search space set being linked” comprises: M PDCCH candidates in the first search space set respectively correspond to M PDCCH candidates in the second search space set, and any PDCCH candidate in the M PDCCH candidates in the first search space set and the corresponding PDCCH candidate in the second search space set are monitored for detecting DCI formats with same information.

In one embodiment, M is an integer.

In one embodiment, M is a positive integer.

In one embodiment, the meaning that “a PDCCH candidate in the first search space set corresponds to a PDCCH candidate in the second search space set” comprises: an index of the PDCCH candidate in the first search space set is the same as an index of the PDCCH candidate in the second search space set.

In one embodiment, the meaning that “a PDCCH candidate in the first search space set corresponds to a PDCCH candidate in the second search space set” comprises: the PDCCH candidate in the first search space set and the PDCCH candidate in the second search space set belong to a same slot.

In one embodiment, the meaning that “a PDCCH candidate in the first search space set corresponds to a PDCCH candidate in the second search space set” comprises: an index of the PDCCH candidate in the first search space set is the same as an index of the PDCCH candidate in the second search space set, and the PDCCH candidate in the first search space set and the PDCCH candidate in the second search space set belong to a same slot.

In one embodiment, the meaning that “a PDCCH candidate in the first search space set corresponds to a PDCCH candidate in the second search space set” comprises: within a first time unit, an index of a PDCCH monitoring occasion in the first search space set is the same as an index of a PDCCH monitoring occasion in the second search space set, and an index of a PDCCH candidate in the PDCCH monitoring occasion in the first search space set is the same as an index of a PDCCH candidate in the PDCCH monitoring occasion in the second search space set.

In one embodiment, the first time unit comprises at least one PDCCH monitoring occasion.

In one embodiment, the first time unit comprises at least one PDCCH monitoring occasion in the first search space set.

In one embodiment, the first time unit comprises at least one PDCCH monitoring occasion in the second search space set.

In one embodiment, the first time unit comprises at least one PDCCH monitoring occasion in the first search space set and at least one PDCCH monitoring occasion in the second search space set.

In one embodiment, the first time unit comprises at least one slot.

In one embodiment, the first time unit comprises a slot.

In one embodiment, the first time unit is a slot.

In one embodiment, the first time unit comprises at least one subframe.

In one embodiment, the first time unit comprises a subframe.

In one embodiment, the first time unit is a subframe.

In one embodiment, the meaning that “a PDCCH candidate in the first search space set corresponds to a PDCCH candidate in the second search space set” comprises: an identifier of the PDCCH candidate in the first search space set is the same as an identifier of the PDCCH candidate in the second search space set.

In one embodiment, the meaning that “a PDCCH candidate in the first search space set corresponds to a PDCCH candidate in the second search space set” comprises: within a first time unit, an index of a PDCCH monitoring occasion in the first search space set is the same as an index of a PDCCH monitoring occasion in the second search space set, and an identifier of a PDCCH candidate in the PDCCH monitoring occasion in the first search space set is the same as an identifier of a PDCCH candidate in the PDCCH monitoring occasion in the second search space set.

In one embodiment, “the first search space set and the second search space set being linked” comprises: the first search space set and the second search space set have a same PDCCH monitoring period and offset, a same number of slots present in a same search space set or a number of slots in consecutive slot groups, a same number of PDCCH candidates for each CCE aggregation level, and a same number of non-overlapping PDCCH monitoring occasions in each slot.

In one embodiment, “the first search space set and the second search space set being linked” comprises: the first search space set and the second search space set have a same PDCCH monitoring period and offset, a same number of slots in a same search space set or a number of slots in consecutive slot groups, a same number of PDCCH candidates for each CCE aggregation level, a same number of non-overlapping PDCCH monitoring occasions in each slot, and a PDCCH candidate in the first search space set and a PDCCH candidate in the second search space set are monitored for detecting DCI formats with same information.

In one embodiment, “the first search space set and the second search space set being linked” comprises: the first search space set and the second search space set have a same PDCCH monitoring period and offset, a same number of slots in a same search space set or a number of slots in consecutive slot groups, a same number of PDCCH candidates for each CCE aggregation level, and a same number of non-overlapping PDCCH monitoring occasions in each slot, and M PDCCH candidates in the first search space set respectively correspond to M PDCCH candidates in the second search space set, and any PDCCH candidate among the M PDCCH candidates in the first search space set and the corresponding PDCCH candidate in the second search space set are monitored for detecting DCI formats with same information.

In one embodiment, the first information block is carried by a higher-layer signaling.

In one embodiment, the first information block is carried by an RRC (Radio Resource Control) signaling.

In one embodiment, the first information block comprises all or partial fields in an RRC IE (Information Element).

In one embodiment, the first information block comprises all or partial fields in each RRC IE in multiple RRC IEs.

In one embodiment, the first information block comprises all or partial fields in a TDD-UL-DL-ConfigCommon IE.

In one embodiment, the first information block comprises all or partial fields in a TDD-UL-DL-ConfigDedicated IE.

In one embodiment, the first information block comprises all or partial fields in a ServingCellConfig IE.

In one embodiment, the first information block comprises all or partial fields in a ServingCellConfigCommonSIB IE.

In one embodiment, the first information block comprises information in all or partial fields in a ServingCellConfigCommon IE.

In one embodiment, the first information block is carried by at least one RRC IE.

In one embodiment, the first information block is carried by a TDD-UL-DL-ConfigCommon IE.

In one embodiment, the first information block is carried by a TDD-UL-DL-ConfigDedicated IE.

In one embodiment, the first information block is carried by a ServingCellConfig IE.

In one embodiment, the first information block is carried by a ServingCellConfigCommonSIB IE.

In one embodiment, the first information block is carried by a ServingCellConfigCommon IE.

In one embodiment, a name of an IE carrying the first information block comprises TDD-UL-DL-Config.

In one embodiment, a name of an IE carrying the first information block comprises ServingCellConfig.

In one embodiment, the first information block is carried by a Medium Access Control layer Control Element (MAC CE).

In one embodiment, the first information block comprises a MAC CE.

In one embodiment, the first information block is carried by DCI (Downlink control information).

In one embodiment, the first information block comprises DCI.

In one embodiment, the first information block comprises one or multiple fields of DCI.

In one embodiment, the first information block is carried by DCI format 2_0.

In one embodiment, the first information block comprises DCI format 2_0.

In one embodiment, the first information block is carried by an RRC signaling and a MAC CE together.

In one embodiment, the first information block is jointly carried by a higher-layer signaling and DCI.

In one embodiment, for specific meanings of TDD-UL-DL-ConfigCommon IE, TDD-UL-DL-

Config Dedicated IE, ServingCellConfig IE, ServingCellConfigCommonSIB IE and ServingCellConfigCommon IE, refer to chapter 6.3.2 in 3GPP TS 38.331.

In one embodiment, for the specific definition of DCI format 2_0, refer to chapter 7.3.1 in 3GPP TS 38.212.

In one embodiment, the first information block indicates the reference time-domain resource set.

In one embodiment, the first information block is used to indicate the reference time-domain resource set.

In one embodiment, the first information block explicitly indicates the reference time-domain resource set.

In one embodiment, the first information block implicitly indicates the reference time-domain resource set.

In one embodiment, the first information block indicates a period and time offset of the reference time-domain resource set.

In one embodiment, the first information block indicates time-domain resources comprised in the reference time-domain resource set within one cycle.

In one embodiment, the first information block indicates symbol(s) comprised in the reference time-domain resource set within one cycle.

In one embodiment, the first information block indicates slot(s) comprised in the reference time-domain resource set within one cycle.

In one embodiment, the first information block indicates which symbols belong to the reference time-domain resource set.

In one embodiment, the first information block configures symbols in the reference time-domain resource set as first type.

In one embodiment, the first information block indicates the reference time-domain resource set by configuring symbols in the reference time-domain resource set as first type.

In one embodiment, the first type is different from downlink (DL) and downlink (UL).

In one embodiment, the first type is different from uplink, downlink and flexible.

In one embodiment, the first type is different from sidelink.

In one embodiment, the first information block indicates the reference time-domain resource set by configuring frequency-domain resources used for uplink for symbols configured by higher-layer parameters as DL or Flexible.

In one embodiment, the higher-layer parameter is an RRC parameter.

In one embodiment, the higher-layer parameter comprises tdd-UL-DL-ConfigurationCommon.

In one embodiment, the higher-layer parameter comprises tdd-UL-DL-ConfigurationDedicated.

In one embodiment, the higher-layer parameter comprises tdd-UL-DL-ConfigurationCommon and tdd-UL-DL-ConfigurationDedicated.

In one embodiment, the higher-layer parameter comprises at least one of tdd-UL-DL-ConfigurationCommon or tdd-UL-DL-ConfigurationDedicated.

In one embodiment, the reference time-domain resource set comprises one or multiple symbols. In one embodiment, the reference time-domain resource set comprises one symbol.

In one embodiment, the reference time-domain resource set comprises multiple symbols.

In one embodiment, the reference time-domain resource set comprises one or multiple symbols of the first type.

In one embodiment, the reference time-domain resource set comprises at least one slot.

In one embodiment, the reference time-domain resource set comprises at least one subframe.

In one embodiment, the symbol is a single carrier symbol.

In one embodiment, the symbol is a multicarrier symbol.

In one embodiment, the multicarrier symbol is an Orthogonal Frequency Division Multiplexing (OFDM) symbol.

In one embodiment, the multicarrier symbol is obtained by after a transform precoding output is through OFDM symbol generation.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multicarrier (FBMC) symbol.

In one embodiment, the multicarrier symbol comprises a Cyclic Prefix (CP).

In one embodiment, the reference time-domain resource set comprises symbols used for both uplink and downlink transmission simultaneously.

In one embodiment, any symbol in the reference time-domain resource set can be used for both uplink transmission and downlink transmission simultaneously.

In one embodiment, any symbol in the reference time-domain resource set is used for both uplink transmission and downlink transmission simultaneously.

In one embodiment, at least one symbol in the reference time-domain resource set is used for both uplink transmission and downlink transmission simultaneously.

In one embodiment, at least one symbol in the reference time-domain resource set is configured for both uplink and downlink.

In one embodiment, at least one symbol in the reference time-domain resource set is used for both uplink and downlink.

In one embodiment, each symbol in the reference time-domain resource set is configured for both uplink and downlink.

In one embodiment, each symbol in the reference time-domain resource set is used for both uplink and downlink.

In one embodiment, at least one symbol in the reference time-domain resource set is configured for uplink in part of RBs and for downlink in another part of RBs.

In one embodiment, at least one symbol in the reference time-domain resource set is used for uplink in part of RBs and used for downlink in another part of RBs.

In one embodiment, each symbol in the reference time-domain resource set is configured for uplink in part of RBs and for downlink in another part of RBs.

In one embodiment, each symbol in the reference time-domain resource set is used for uplink in part of RBs and used for downlink in another part of RBs.

In one embodiment, at least one symbol in the reference time-domain resource set is configured for uplink in part of RBs within a same cell, and for downlink in another part of RBs.

In one embodiment, at least one symbol in the reference time-domain resource set is used for uplink in part of RBs within a same cell, and used for downlink in another part of RBs.

In one embodiment, each symbol in the reference time-domain resource set is configured for uplink in part of RBs within a same cell, and for downlink in another part of RBs.

In one embodiment, each symbol in the reference time-domain resource set is used for uplink in part of RBs within a same cell, and used for downlink in another part of RBs.

In one embodiment, the RB comprises a positive integer number of subcarrier(s).

In one embodiment, the RB comprises a positive integer number of consecutive subcarriers.

In one embodiment, the RB comprises 12 consecutive subcarriers.

In one embodiment, for the specific definition of the RB, refer to chapter 4 in 3GPP TS 38.211.

In one embodiment, the same cell is a cell where the first information block is transmitted.

In one embodiment, the same cell is a cell in which the first information block is configured.

In one embodiment, the same cell is a cell comprising the first information block.

In one embodiment, the same cell is a cell where the second information block is transmitted.

In one embodiment, the same cell is a cell in which the second information block is configured.

In one embodiment, the same cell is a cell comprising the second information block.

In one embodiment, the same cell is a serving cell.

In one embodiment, the reference time-domain resource set comprises symbols used for full duplex/SBFD.

In one embodiment, each symbol in the reference time-domain resource set is used for full duplex/SBFD.

In one embodiment, a problem to be solved in the present application comprises: how to determine QCL information of a DMRS antenna port for PDCCH reception on a PDCCH candidate in two linked search space sets in systems that support full duplex/SBFD or support uplink and downlink transmission within a same symbol. In the above method, QCL information of a DMRS antenna port for PDCCH reception on a PDCCH candidate in the two linked search space sets depends on whether it overlaps with the reference time-domain resource set, solving this problem.

In one embodiment, advantages of the above method comprise: simple implementation, providing better QCL information, and enhancing the performance of PDCCH reception.

In one embodiment, any symbol not belonging to the reference time-domain resource set is only used for uplink or only for downlink.

In one embodiment, any symbol not belonging to the reference time-domain resource set is only configured for uplink or only configured for downlink.

In one embodiment, any symbol not belonging to the reference time-domain resource set is only used for uplink or only for downlink in the same cell.

In one embodiment, any symbol not belonging to the reference time-domain resource set is only configured for uplink or only configured for downlink in the same cell.

In one embodiment, the first node monitors at least a first PDCCH candidate in the first search space set and at least a second PDCCH candidate in the second search space set.

In one embodiment, the first node monitors multiple PDCCH candidates in the first search space set and multiple PDCCH candidates in the second search space set, the multiple PDCCH candidates in the first search space set comprise the first PDCCH candidate, and the multiple PDCCH candidates in the second search space set comprise the second PDCCH candidate.

In one embodiment, the first node also monitors a PDCCH candidate in a search space set other than the first search space set and the second search space set.

In one embodiment, the first node also monitors one or multiple PDCCH candidates in a search space set other than the first search space set and the second search space set.

In one embodiment, the first search space set comprises at least one PDCCH monitoring occasion.

In one embodiment, the second search space set comprises at least one PDCCH monitoring occasion.

In one embodiment, the first search space set comprises at least one PDCCH monitoring occasion in the first time unit.

In one embodiment, the second search space set comprises at least one PDCCH monitoring occasion in the first time unit.

In one embodiment, the first node monitors at least one PDCCH candidate in a PDCCH monitoring occasion in the first search space set.

In one embodiment, the first node monitors at least one PDCCH candidate in a PDCCH monitoring occasion in the second search space set.

In one embodiment, the meaning of the “monitoring” comprises: receiving.

In one embodiment, the meaning of the “monitoring” comprises: performing decoding on PDCCH candidates.

In one embodiment, the meaning of the “monitoring” comprises: performing blind decoding on PDCCH candidates.

In one embodiment, the meaning of the “monitoring” comprises: performing decoding and CRC (Cyclic Redundancy Check) check on a PDCCH candidate.

In one embodiment, the meaning of the “monitoring” comprises: performing decoding and a CRC check scrambled by an RNTI on a PDCCH.

In one embodiment, the meaning of the “monitoring” comprises: performing decoding on PDCCH candidates based on monitored DCI format(s).

In one embodiment, the meaning of the “monitoring” comprises: performing decoding on PDCCH candidates based on monitored one or multiple DCI format(s).

In one embodiment, the second PDCCH candidate and the first PDCCH candidate are comprised by a PDCCH reception.

In one embodiment, the second PDCCH candidate and the first PDCCH candidate belong to a same PDCCH reception.

In one embodiment, the second PDCCH candidate is a PDCCH candidate linked to the first PDCCH candidate in the second search space set.

In one embodiment, the second PDCCH candidate and the first PDCCH candidate are monitored for detecting DCI formats with same information.

In one embodiment, an index of the second PDCCH candidate in the second search space set is the same as an index of the first PDCCH candidate in the first search space set.

In one embodiment, the second PDCCH candidate and the first PDCCH candidate belong to a same slot in time domain.

In one embodiment, the second PDCCH candidate and the first PDCCH candidate belong to a same slot in time domain, and an index of a PDCCH monitoring occasion where the first PDCCH candidate is located is the same as an index of a PDCCH monitoring occasion where the second PDCCH candidate is located.

In one embodiment, an index of the second PDCCH candidate in the second search space set and an index of the first PDCCH candidate in the first search space set are the same, the second PDCCH candidate and the first PDCCH candidate belong to a same slot in time domain, and an index of a PDCCH monitoring occasion where the first PDCCH candidate is located is the same as an index of a PDCCH monitoring occasion where the second PDCCH candidate is located.

In one embodiment, the first PDCCH candidate and the second PDCCH candidate comprise at least one same symbol in time domain.

In one embodiment, the first PDCCH candidate and the second PDCCH candidate are orthogonal in time domain.

In one embodiment, the first PDCCH candidate and the second PDCCH candidate are overlapping in time domain.

In one embodiment, “the first PDCCH candidate and the second PDCCH candidate being monitored for detecting DCI formats with same information” comprises: a DCI format that the first PDCCH candidate is monitored for detection and a DCI format that the second PDCCH candidate is monitored for detection have same information.

In one embodiment, “the first PDCCH candidate and the second PDCCH candidate being monitored for detecting DCI formats with same information” comprises: the first PDCCH candidate and the second PDCCH candidate are used by the first node to monitor for detecting DCI formats with same information.

In one embodiment, “the first PDCCH candidate and the second PDCCH candidate being monitored for detecting DCI formats with same information” comprises: monitoring for the first PDCCH candidate and the second PDCCH candidate is assumed by the first node to detect a DCI format with same information.

In one embodiment, “the first PDCCH candidate and the second PDCCH candidate being monitored for detecting DCI formats with same information” comprises: the first PDCCH candidate and the second PDCCH candidate are monitored by the first node, and the first node assumes that a DCI format that the first PDCCH candidate is monitored for detection and a DCI format that the second PDCCH candidate is monitored for detection have same information.

In one embodiment, at least one of QCL information of a DMRS antenna port for a PDCCH reception on the first PDCCH candidate or QCL information of a DMRS antenna port for a PDCCH reception on the second PDCCH candidate depends on whether one of the first PDCCH candidate or the second PDCCH candidate overlaps with the reference time-domain resource set in time domain.

In one embodiment, at least one of QCL information of a DMRS antenna port for a PDCCH reception on the first PDCCH candidate or QCL information of a DMRS antenna port for a PDCCH reception on the second PDCCH candidate depends on whether the first PDCCH candidate overlaps with the reference time-domain resource set in time domain.

In one embodiment, at least one of QCL information of a DMRS antenna port for a PDCCH reception on the first PDCCH candidate or QCL information of a DMRS antenna port for a PDCCH reception on the second PDCCH candidate depends on whether the second PDCCH candidate overlaps with the reference time-domain resource set in time domain.

In one embodiment, at least one of QCL information of a DMRS antenna port for a PDCCH reception on the first PDCCH candidate or QCL information of a DMRS antenna port for a PDCCH reception on the second PDCCH candidate depends on whether the first PDCCH candidate or the second PDCCH candidate overlaps with the reference time-domain resource set in time domain.

In one embodiment, at least one of QCL information of a DMRS antenna port for a PDCCH reception on a first PDCCH candidate or QCL information of a DMRS antenna port for a PDCCH reception on the second PDCCH candidate depends on whether the first PDCCH candidate overlaps with the reference time-domain resource set in time domain and whether the second PDCCH candidate overlaps with the reference time-domain resource set in time domain.

In one embodiment, only one of QCL information of a DMRS antenna port for a PDCCH reception on the first PDCCH candidate and QCL information of a DMRS antenna port for a PDCCH reception on the second PDCCH candidate depends on whether one of the first PDCCH candidate or the second PDCCH candidate overlaps with the reference time-domain resource set in time domain.

In one embodiment, only one of QCL information of a DMRS antenna port for a PDCCH reception on the first PDCCH candidate and QCL information of a DMRS antenna port for a PDCCH reception on the second PDCCH candidate depends on whether the first PDCCH candidate overlaps with the reference time-domain resource set in time domain.

In one embodiment, only one of QCL information of a DMRS antenna port for a PDCCH reception on the first PDCCH candidate and QCL information of a DMRS antenna port for a PDCCH reception on the second PDCCH candidate depends on whether the second PDCCH candidate overlaps with the reference time-domain resource set in time domain.

In one embodiment, only one of QCL information of a DMRS antenna port for a PDCCH reception on the first PDCCH candidate and QCL information of a DMRS antenna port for a PDCCH reception on the second PDCCH candidate depends on whether the first PDCCH candidate or the second PDCCH candidate overlaps with the reference time-domain resource set in time domain.

In one embodiment, only one of QCL information of a DMRS antenna port for a PDCCH reception on a first PDCCH candidate and QCL information of a DMRS antenna port for a PDCCH reception on the second PDCCH candidate depends on whether the first PDCCH candidate overlaps with the reference time-domain resource set in time domain and whether the second PDCCH candidate overlaps with the reference time-domain resource set in time domain.

In one embodiment, QCL information of a DMRS antenna port for a PDCCH reception on the first PDCCH candidate and QCL information of a DMRS antenna port for a PDCCH reception on the second PDCCH candidate depends on whether one of the first PDCCH candidate or the second PDCCH candidate overlaps with the reference time-domain resource set in time domain.

In one embodiment, QCL information of a DMRS antenna port for a PDCCH reception on the first PDCCH candidate and QCL information of a DMRS antenna port for a PDCCH reception on the second PDCCH candidate depends on whether the first PDCCH candidate overlaps with the reference time-domain resource set in time domain.

In one embodiment, QCL information of a DMRS antenna port for a PDCCH reception on the first PDCCH candidate and QCL information of a DMRS antenna port for a PDCCH reception on the second PDCCH candidate depends on whether the second PDCCH candidate overlaps with the reference time-domain resource set in time domain.

In one embodiment, QCL information of a DMRS antenna port for a PDCCH reception on the first PDCCH candidate and QCL information of a DMRS antenna port for a PDCCH reception on the second PDCCH candidate depends on whether the first PDCCH candidate or the second PDCCH candidate overlaps with the reference time-domain resource set in time domain.

In one embodiment, QCL information of a DMRS antenna port for a PDCCH reception on a first PDCCH candidate and QCL information of a DMRS antenna port for a PDCCH reception on the second PDCCH candidate depend on whether the first PDCCH candidate overlaps with the reference time-domain resource set in time domain and whether the second PDCCH candidate overlaps with the reference time-domain resource set in time domain.

In one embodiment, the meaning of “the first PDCCH candidate being overlapping with the reference time-domain resource set in time domain” comprises: there exists at least one symbol in time-domain resources occupied by the first PDCCH candidate being overlapping with the reference time-domain resource set.

In one embodiment, the meaning of “the first PDCCH candidate being overlapping with the reference time-domain resource set in time domain” comprises: there exists at least one symbol in time-domain resources occupied by the first PDCCH candidate belonging to the reference time-domain resource set.

In one embodiment, the meaning of “the first PDCCH candidate being overlapping with the reference time-domain resource set in time domain” comprises: multiple symbols in time-domain resources occupied by the first PDCCH candidate are overlapping with the reference time-domain resource set.

In one embodiment, the meaning of “the first PDCCH candidate being overlapping with the reference time-domain resource set in time domain” comprises: multiple symbols in time-domain resources occupied by the first PDCCH candidate belong the reference time-domain resource set.

In one embodiment, the meaning of “the first PDCCH candidate being overlapping with the reference time-domain resource set in time domain” comprises: part of time-domain resources occupied by the first PDCCH candidate are overlapping with the reference time-domain resource set.

In one embodiment, the meaning of “the first PDCCH candidate being overlapping with the reference time-domain resource set in time domain” comprises: time-domain resources occupied by the first PDCCH candidate belong to the reference time-domain resource set.

In one embodiment, the meaning of “the second PDCCH candidate being overlapping with the reference time-domain resource set in time domain” comprises: there exists at least one symbol in time-domain resources occupied by the second PDCCH candidate being overlapping with the reference time-domain resource set.

In one embodiment, the meaning of “the second PDCCH candidate being overlapping with the reference time-domain resource set in time domain” comprises: there exists at least one symbol in time-domain resources occupied by the second PDCCH candidate belonging to the reference time-domain resource set.

In one embodiment, the meaning of “the second PDCCH candidate being overlapping with the reference time-domain resource set in time domain” comprises: multiple symbols in time-domain resources occupied by the second PDCCH candidate are overlapping with the reference time-domain resource set.

In one embodiment, the meaning of “the second PDCCH candidate being overlapping with the reference time-domain resource set in time domain” comprises: multiple symbols in time-domain resources occupied by the second PDCCH candidate belong the reference time-domain resource set.

In one embodiment, the meaning of “the second PDCCH candidate being overlapping with the reference time-domain resource set in time domain” comprises: part of time-domain resources occupied by the second PDCCH candidate is overlapping with the reference time-domain resource set.

In one embodiment, the meaning of “the second PDCCH candidate being overlapping with the reference time-domain resource set in time domain” comprises: time-domain resources occupied by the second PDCCH candidate belong to the reference time-domain resource set.

In one embodiment, at least one of QCL (quasi co-location) information of a DMRS antenna port for a PDCCH reception on the first PDCCH candidate or QCL information of a DMRS antenna port for a PDCCH reception on the second PDCCH candidate depends on whether the first PDCCH candidate and the second PDCCH candidate occupy a same type of symbol in two types of symbols in time domain.

In one embodiment, at least one of QCL information of a DMRS antenna port for a PDCCH reception on the first PDCCH candidate or QCL information of a DMRS antenna port for a PDCCH reception on the second PDCCH candidate depends on whether the first PDCCH candidate and the second PDCCH candidate occupy a symbol of a first type in time domain.

In one embodiment, when both the first PDCCH candidate and the second PDCCH candidate are orthogonal to the reference time-domain resource set in time domain, the DMRS antenna port for the PDCCH reception on the first PDCCH candidate and a first RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located.

In one embodiment, when both the first PDCCH candidate and the second PDCCH candidate are orthogonal to the reference time-domain resource set in time domain, a DMRS antenna port for a PDCCH reception on the second PDCCH candidate and a second RS resource are quasi co-located; when both the first PDCCH candidate and the second PDCCH candidate belong to the reference time-domain resource set in time domain, a DMRS antenna port for a PDCCH reception on the second PDCCH candidate and a fourth RS resource are quasi co-located.

In one embodiment, when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and the first RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and the third RS resource are quasi co-located.

In one embodiment, when both the first PDCCH candidate and the second PDCCH candidate are orthogonal to the reference time-domain resource set in time domain, or when both the first PDCCH candidate and the second PDCCH candidate belong to the reference time-domain resource set in time domain, a DMRS antenna port for a PDCCH reception on the second PDCCH candidate and the second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, a DMRS antenna port for a PDCCH reception on the second PDCCH candidate and the fourth RS resource are quasi co-located.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), air vehicles, narrow-band physical network devices, machine-type communication devices, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

In one embodiment, a radio link between the UE 201 and the gNB 203 comprises a cellular network link.

In one embodiment, a transmitter of the first information block comprises the gNB 203.

In one embodiment, a receiver of the first information block comprises the UE 201.

In one embodiment, a transmitter of the second information block comprises the gNB 203.

In one embodiment, a receiver of the second information block comprises the UE 201.

In one embodiment, the gNB 203 supports SBFD.

In one embodiment, the gNB 203 supports more flexible duplex mode or full duplex mode.

In one embodiment, the UE201 supports SBFD.

In one embodiment, the UE 201 supports more flexible duplex mode or full duplex mode.

### Embodiment 3

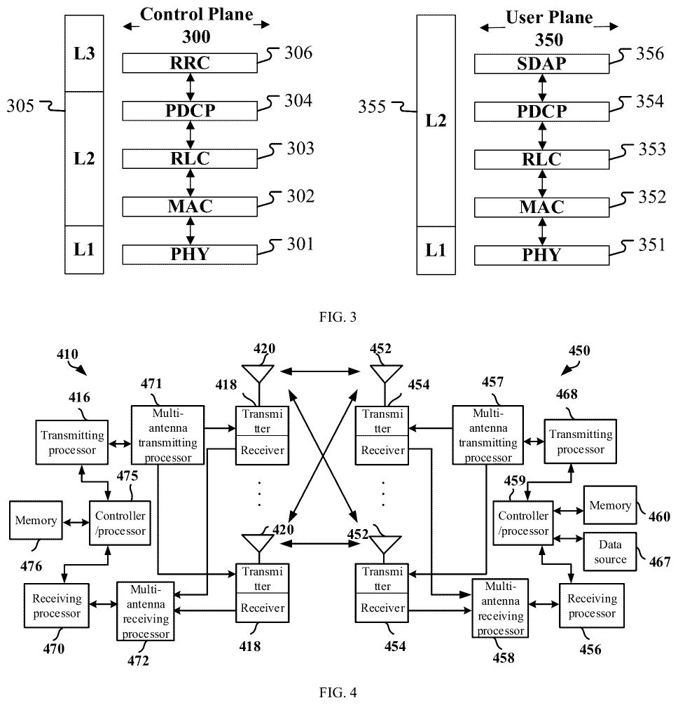

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The

Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the higher layer in the present application refers to a layer above the physical layer.

In one embodiment, the first information block is generated by the RRC sublayer 306.

In one embodiment, the first information block is generated by the MAC sublayer 302 or the MAC sublayer 352.

In one embodiment, the first information block is generated by the PHY 301 or the PHY 351.

In one embodiment, the second information block is generated by the RRC sublayer 306.

In one embodiment, the second information block is generated by the MAC sublayer 302 or the MAC sublayer 352.

In one embodiment, the third information block is generated by the RRC sublayer 306.

In one embodiment, the third information block is generated by the MAC sublayer 302 or the MAC sublayer 352.

### Embodiment 4

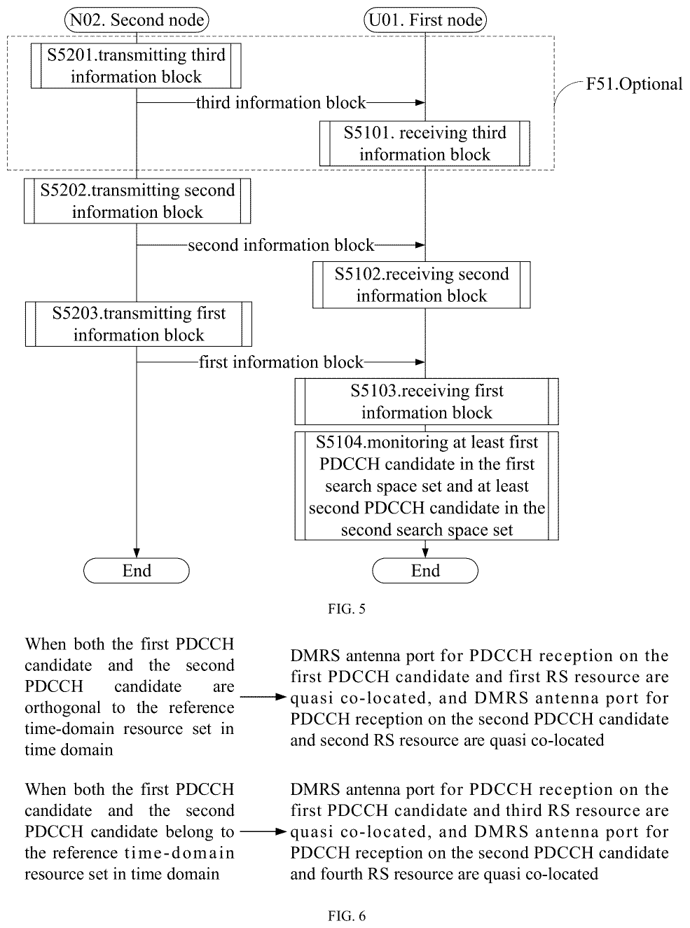

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the LI layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DownLink) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least; receives a second information block, the second information block is used to determine that a first search space set and a second search space set are linked; receives a first information block, the first information block is used to determine a reference time-domain resource set; monitors at least a first PDCCH candidate in the first search space set and at least a second PDCCH candidate in the second search space set; herein, the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, the second communication device 450 comprises a memory that stores a computer readable instruction program. The computer readable instruction program generates an action when executed by at least one processor. The action includes: receiving a second information block, the second information block being used to determine that a first search space set and a second search space set are linked; receiving a first information block, the first information block being used to determine a reference time-domain resource set; monitoring at least a first PDCCH candidate in the first search space set and at least a second PDCCH candidate in the second search space set; herein, the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, the first communication device 410 comprises at least one processor and at least one memory. The at least one memory comprises computer program codes; the at least one memory and the computer program codes are configured to be used in collaboration with the at least one processor. The first communication device 410 at least; transmits a second information block, the second information block is used to determine that a first search space set and a second search space set are linked; transmits a first information block, the first information block is used to determine a reference time-domain resource set; herein, a receiver of the second information block monitors at least a first PDCCH candidate in the first search space set and at least a second PDCCH candidate in the second search space set; the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, the first communication device 410 comprises a memory that stores a computer readable instruction program. The computer readable instruction program generates an action when executed by at least one processor. The action includes: transmitting a second information block, the second information block being used to determine that a first search space set and a second search space set are linked; transmitting a first information block, the first information block being used to determine a reference time-domain resource set; herein, a receiver of the second information block monitors at least a first PDCCH candidate in the first search space set and at least a second PDCCH candidate in the second search space set; the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, the first node in the present application comprises the second communication device 450.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first information block in the present application; at least one of the antenna 420, the transmitter 418, the transmitting processor 416, the multi-antenna transmitting processor 471, the controller/processor 475, or the memory 476 is used for transmitting the first information block in the present application.

In one embodiment, at least one of the antenna 452, the receiver 454, the receiving processor 456, the multi-antenna receiving processor 458, the controller/processor 459, the memory 460, or the data source 467 is used to receive the second information block in the present application; at least one of the antenna 420, the transmitter 418, the transmitting processor 416, the multi-antenna transmitting processor 471, the controller/processor 475, or the memory 476 is used to transmit the second information block in the present application.

In one embodiment, at least one of the antenna 452, the receiver 454, the receiving processor 456, the multi-antenna receiving processor 458, the controller/processor 459, the memory 460, or the data source 467 is used to receive the third information block in the present application; at least one of the antenna 420, the transmitter 418, the transmitting processor 416, the multi-antenna transmitting processor 471, the controller/processor 475, or the memory 476 is used to transmit the third information block in the present application.

### Embodiment 5

Embodiment 5 illustrates a flowchart of transmission according to one embodiment in the present application, as shown in FIG. 5. In FIG. 5, the first node U01 and the second node N02 are respectively two communication nodes transmitted through an air interface, with steps in box F51 being optional.

The first node U01 receives a third information block in step S5101; receives a second information block in step S5102; receives a first information block in step S5103; monitors at least a first PDCCH candidate in the first search space set and at least a second PDCCH candidate in the second search space set in step S5104.

The second node N02 transmits a third information block in step S5201; transmits a second information block in step S5202; transmits a first information block in step S5203.

In embodiment 5, the second information block is used to determine that a first search space set and a second search space set are linked; the first information block is used to determine a reference time-domain resource set; herein, the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, the first node U01 is the first node in the present application.

In one embodiment, the second node N02 is the second node in the present application.

In one embodiment, an air interface between the second node N02 and the first node U01 comprises a radio interface between a base station and a UE.

In one embodiment, an air interface between the second node N02 and the first node U01 comprises a radio interface between a relay node and a UE.

In one embodiment, an air interface between the second node N02 and the first node U01 comprises a radio interface between a UE and a UE.

In one embodiment, the second node N02 is a maintenance base station for a serving cell of the first node N01.

In one embodiment, the second information block is used by the first node U01 to determine that the first search space set and the second search space set are linked.

In one embodiment, the first information block is used by the first node U01 to determine the reference time-domain resource set.

In one embodiment, steps in dashed box F51 do not exist.

In one embodiment, steps in dashed box F51 exist.

In one embodiment, steps in dashed box F51 exist, and the above method in a first node U01 for wireless communications comprises: receiving a third information block; herein, the third information block indicates configuration information of a first CORESET and configuration information of a second CORESET; the first CORESET is associated with the first search space set, and the second CORESET is associated with the second search space set.

In one embodiment, steps in dashed box F51 exist, and the above method in a second node N02 for wireless communications comprises: transmitting a third information block; herein, the third information block indicates configuration information of a first CORESET and configuration information of a second CORESET; the first CORESET is associated with the first search space set, and the second CORESET is associated with the second search space set.

In one embodiment, the third information block and the second information block belong to a same RRC IE.

In one embodiment, the third information block and the second information block belong to a same RRC IE whose name comprises “PDCCH-Config”.

In one embodiment, the third information block and the second information block belong to a same IE PDCCH-Config.

In one embodiment, the third information block and the second information block respectively belong to two RRC IEs.

In one embodiment, the third information block and the second information block are received at the same time.

In one embodiment, the third information block and the second information block are received together.

In one embodiment, a reception of the third information block is not later than a reception of the second information block.

In one embodiment, a reception of the third information block is earlier than a reception of the second information block.

In one embodiment, a reception of the third information block is later than a reception of the second information block.

In one embodiment, a reception of the third information block is not earlier than a reception of the second information block.

In one embodiment, a reception of the first information block is not later than a reception of the second information block.

In one embodiment, a reception of the first information block is earlier than a reception of the second information block.

In one embodiment, a reception of the first information block is later than a reception of the second information block.

In one embodiment, a reception of the first information block is not earlier than a reception of the second information block.

In one embodiment, the first information block is transmitted in a PDSCH (Physical Downlink Shared Channel).

In one embodiment, the first information is transmitted in a Physical Downlink Control Channel (PDCCH).

In one embodiment, the first information block and the second information block belong to a same RRC IE.

In one embodiment, the first information block and the second information block belong to different RRC IEs.

In one embodiment, the second information block is transmitted in a PDSCH.

In one embodiment, the third information block is transmitted in a PDSCH.

In one embodiment, the second information block and the third information block are transmitted in a same PDSCH.

In one embodiment, the second information block and the third information block are transmitted in different PDSCHs.

### Embodiment 6

Embodiment 6 illustrates a schematic diagram of RS resources quasi co-located with a DMRS antenna port for a PDCCH reception on a first PDCCH candidate and RS resources quasi co-located with a DMRS antenna port for a PDCCH reception on a second PDCCH candidate according to one embodiment of the present application, as shown in FIG. 6.

In embodiment 6, when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, when both the first PDCCH candidate and the second PDCCH candidate are orthogonal to the reference time-domain resource set in time domain, a first TCI state indicates QCL information of a DMRS antenna port for a PDCCH reception on the first PDCCH candidate, and a second TCI state indicates QCL information of a DMRS antenna port for a PDCCH reception on the second PDCCH candidate; when both the first PDCCH candidate and the second PDCCH candidate belong to the reference time-domain resource set in time domain, a third TCI state indicates QCL information of a DMRS antenna port for a PDCCH reception on the first PDCCH candidate, and a fourth TCI state indicates QCL information of a DMRS antenna port for a PDCCH reception on the second PDCCH candidate.

In one embodiment, a determination of at least one of QCL information of a DMRS antenna port for a PDCCH reception on the first PDCCH candidate or QCL information of a DMRS antenna port for a PDCCH reception on the second PDCCH candidate depends on whether the first PDCCH candidate and the second PDCCH candidate are orthogonal to or belong to the reference time-domain resource set in time domain.

In one embodiment, a determination of QCL information of a DMRS antenna port for a PDCCH reception on the first PDCCH candidate or a determination of QCL information of a DMRS antenna port for a PDCCH reception on the second PDCCH candidate depends on whether the first PDCCH candidate and the second PDCCH candidate are orthogonal to or belong to the reference time-domain resource set in time domain.

In one embodiment, a TCI state comprises parameters for configuring QCL information between one or more CSI-RS ports of PDSCH's DMRS, PDCCH's DMRS, or CSI-RS (Channel State Information Reference Signal) resources, and one or two RSs, and provides reference RSs for determining PUSCH (Physical Uplink Shared Channel), PUCCH (Physical Uplink Control Channel) resources, and SRS (Sound Reference Signal) uplink transmission spatial filters (UL Tx spatial filters).

In one embodiment, a TCI state comprises parameters for configuring QCL information between one or more CSI-RS ports of PDSCH's DMRS, PDCCH's DMRS or CSI-RS resources, and one or two RSs, or providing a reference RS for determining the uplink transmission spatial filter (UL Tx spatial filter) of PUSCH, PUCCH resources, and SRS.

In one embodiment, the first TCI state is a TCI state.

In one embodiment, the second TCI state is a TCI state.

In one embodiment, the third TCI state is a TCI state.

In one embodiment, the fourth TCI state is a TCI state.

In one embodiment, “a first TCI state indicates QCL information of a DMRS antenna port for a PDCCH reception on the first PDCCH candidate” comprises: the first TCI state indicates RS resources that provide QCL information; “a second TCI state indicates QCL information of a DMRS antenna port for a PDCCH reception on the second PDCCH candidate” comprises: the second TCI state indicates RS resources that provide QCL information.

In one subembodiment of the above embodiment, the meaning of “the first TCI state indicates RS resources that provide QCL information” comprises: the first TCI state indicates an index of RS resources that provide QCL information; the meaning of “the second TCI state indicating an index of RS resources that provide QCL information” comprises: the second TCI state indicates an index of RS resources that provide QCL information.

In one subembodiment of the above embodiment, the meaning of “the first TCI state indicates RS resources that provide QCL information” comprises: the first TCI state indicates an identifier of RS resources that provide QCL information; the meaning of “the second TCI state indicating an index of RS resources that provide QCL information” comprises: the second TCI state indicates an identifier of RS resources that provide QCL information.

In one embodiment, “a first TCI state indicates QCL information of a DMRS antenna port for a PDCCH reception on the first PDCCH candidate” comprises: the first TCI state indicates a serving cell configured with RS resources that provide QCL information; “a second TCI state indicates QCL information of a DMRS antenna port for a PDCCH reception on the second PDCCH candidate” comprises: the second TCI state indicates a serving cell configured with RS resources that provide QCL information.

In one subembodiment of the above embodiment, the meaning of “the first TCI state indicating a serving cell configured with RS resources that provide QCL information” comprises: the first TCI state indicates an index of a serving cell configured with RS resources that provide QCL information; the meaning of “the second TCI state indicating a serving cell configured with RS resources that provide QCL information” comprises: the second TCI state indicates an index of a serving cell configured with RS resources that provide QCL information.

In one subembodiment of the above embodiment, the meaning of “the first TCI state indicating a serving cell configured with RS resources that provide QCL information” comprises: the first TCI state indicates an identifier of a serving cell configured with RS resources that provide QCL information; the meaning of “the second TCI state indicating a serving cell configured with RS resources that provide QCL information” comprises: the second TCI state indicates an identifier of a serving cell configured with RS resources that provide QCL information.

In one embodiment, “a first TCI state indicates QCL information of a DMRS antenna port for a PDCCH reception on the first PDCCH candidate” comprises: the first TCI state indicates a BWP (BandWidth Part) where RS resources that provide QCL information are located; “a second TCI state indicates QCL information of a DMRS antenna port for a PDCCH reception on the second PDCCH candidate” comprises: the second TCI state indicates a BWP where RS resources that provide QCL information are located.

In one subembodiment of the above embodiment, the meaning of “the first TCI state indicates a BWP where RS resources that provide QCL information are located” comprises: the first TCI state indicates an identifier of a BWP where RS resources that provide QCL information are located; the meaning of “the second TCI state indicating a BWP where RS resources that provide QCL information are located” comprises: the second TCI state indicates an identifier of a BWP where RS resources that provide QCL information are located.

In one subembodiment of the above embodiment, the meaning of “the first TCI state indicates a BWP where RS resources that provide QCL information are located” comprises: the first TCI state indicates an index of a BWP where RS resources that provide QCL information are located; the meaning of “the second TCI state indicating a BWP where RS resources that provide QCL information are located” comprises: the second TCI state indicates an index of a BWP where RS resources that provide QCL information are located.

In one embodiment, “a first TCI state indicates QCL information of a DMRS antenna port for a PDCCH reception on the first PDCCH candidate” comprises: the first TCI state indicates QCL type; “a second TCI state indicates QCL information of a DMRS antenna port for a PDCCH reception on the second PDCCH candidate” comprises: the second TCI state indicates QCL type.

In one embodiment, “a first TCI state indicates QCL information of a DMRS antenna port for a PDCCH reception on the first PDCCH candidate” comprises: the first TCI state indicates at least first two of RS resources that provide QCL information, QCL type, a serving cell configured with RS resources that provide QCL information, and a BWP where RS resources that provide QCL information are located; “a second TCI state indicates QCL information of a DMRS antenna port for a PDCCH reception on the second PDCCH candidate” comprises: the second TCI state indicates at least first two of RS resources that provide QCL information, QCL type, a serving cell configured with RS resources that provide QCL information, and a BWP where RS resources that provide QCL information are located.

In one embodiment, “a first TCI state indicates QCL information of a DMRS antenna port for a PDCCH reception on the first PDCCH candidate” comprises: the first TCI state indicates RS resources that provide QCL information, QCL type, a serving cell configured with RS resources that provide QCL information, and a BWP where RS resources that provide QCL information are located; “a second TCI state indicates QCL information of a DMRS antenna port for a PDCCH reception on the second PDCCH candidate” comprises: the second TCI state indicates RS resources that provide QCL information, QCL type, a serving cell configured with RS resources that provide QCL information, and a BWP where RS resources that provide QCL information are located.

In one embodiment, “the first TCI state indicating RS resources that provide QCL information” refers to: the first TCI state indicates RS resources that provide QCL information of a DMRS antenna port for a PDCCH reception on the first PDCCH candidate.

In one embodiment, “the first TCI state indicating RS resources that provide QCL information” refers to: the first TCI state indicates RS resources quasi co-located with a DMRS antenna port for a PDCCH reception on the first PDCCH candidate.

In one embodiment, “the second TCI state indicates RS resources that provide QCL information” refers to: the second TCI state indicates RS resources that provide QCL information of a DMRS antenna port for a PDCCH reception on the second PDCCH candidate.

In one embodiment, “the second TCI state indicates RS resources that provide QCL information” refers to: the second TCI state indicates RS resources quasi co-located with a DMRS antenna port for a PDCCH reception on the second PDCCH candidate.

In one embodiment, “the first TCI state indicating QCL type” refers to: the first TCI state indicates a QCL type between RS resources that provide QCL information indicated by the first TCI state and a DMRS antenna port for a PDCCH reception on the first PDCCH candidate.

In one embodiment, “the first TCI state indicating QCL type” refers to: the first TCI state indicates a QCL type corresponding to RS resources that provide QCL information indicated by the first TCI state.

In one embodiment, “the first TCI state indicating QCL type” refers to: the first TCI state indicates a QCL type configured for RS resources that provide QCL information indicated by the first TCI state.

In one embodiment, “the second TCI state indicating QCL type” refers to: the second TCI state indicates a QCL type between RS resources that provide QCL information indicated by the second TCI state and a DMRS antenna port for a PDCCH reception on the second PDCCH candidate.

In one embodiment, “the second TCI state indicating QCL type” refers to: the second TCI state indicates a QCL type corresponding to RS resources that provide QCL information indicated by the second TCI state.

In one embodiment, “the second TCI state indicating QCL type” refers to: the second TCI state indicates a QCL type configured for RS resources that provide QCL information indicated by the second TCI state.

In one embodiment, “a third TCI state indicates QCL information of a DMRS antenna port for a PDCCH reception on the first PDCCH candidate” comprises: the third TCI state indicates RS resources that provide QCL information; “a fourth TCI state indicates QCL information of a DMRS antenna port for a PDCCH reception on the second PDCCH candidate” comprises: the fourth TCI state indicates RS resources that provide QCL information.

In one subembodiment of the above embodiment, the meaning of “the third TCI state indicates RS resources that provide QCL information” comprises: the third TCI state indicates an index of RS resources that provide QCL information; the meaning of “the fourth TCI state indicating an index of RS resources that provide QCL information” comprises: the fourth TCI state indicates an index of RS resources that provide QCL information.

In one subembodiment of the above embodiment, the meaning of “the third TCI state indicates RS resources that provide QCL information” comprises: the third TCI state indicates an identifier of RS resources that provide QCL information; the meaning of “the fourth TCI state indicating an index of RS resources that provide QCL information” comprises: the fourth TCI state indicates an identifier of RS resources that provide QCL information.

In one embodiment, “a third TCI state indicates QCL information of a DMRS antenna port for a PDCCH reception on the first PDCCH candidate” comprises: the third TCI state indicates a serving cell configured with RS resources that provide QCL information; “a fourth TCI state indicates QCL information of a DMRS antenna port for a PDCCH reception on the second PDCCH candidate” comprises: the fourth TCI state indicates a serving cell configured with RS resources that provide QCL information.

In one subembodiment of the above embodiment, the meaning of “the third TCI state indicating a serving cell configured with RS resources that provide QCL information” comprises: the third TCI state indicates an index of a serving cell configured with RS resources that provide QCL information; the meaning of “the fourth TCI state indicating a serving cell configured with RS resources that provide QCL information” comprises: the fourth TCI state indicates an index of a serving cell configured with RS resources that provide QCL information.

In one subembodiment of the above embodiment, the meaning of “the third TCI state indicating a serving cell configured with RS resources that provide QCL information” comprises: the third TCI state indicates an identifier of a serving cell configured with RS resources that provide QCL information; the meaning of “the fourth TCI state indicating a serving cell configured with RS resources that provide QCL information” comprises: the fourth TCI state indicates an identifier of a serving cell configured with RS resources that provide QCL information.

In one embodiment, “a third TCI state indicates QCL information of a DMRS antenna port for a PDCCH reception on the first PDCCH candidate” comprises: the third TCI state indicates a BWP where RS resources that provide QCL information are located; “a fourth TCI state indicates QCL information of a DMRS antenna port for a PDCCH reception on the second PDCCH candidate” comprises: the fourth TCI state indicates a BWP where RS resources that provide QCL information are located.

In one subembodiment of the above embodiment, the meaning of “the third TCI state indicates a BWP where RS resources that provide QCL information are located” comprises: the third TCI state indicates an identifier of a BWP where RS resources that provide QCL information are located; the meaning of “the fourth TCI state indicating a BWP where RS resources that provide QCL information are located” comprises: the fourth TCI state indicates an identifier of a BWP where RS resources that provide QCL information are located.

In one subembodiment of the above embodiment, the meaning of “the third TCI state indicates a BWP where RS resources that provide QCL information are located” comprises: the third TCI state indicates an index of a BWP where RS resources that provide QCL information are located; the meaning of “the fourth TCI state indicating a BWP where RS resources that provide QCL information are located” comprises: the fourth TCI state indicates an index of a BWP where RS resources that provide QCL information are located.

In one embodiment, “a third TCI state indicates QCL information of a DMRS antenna port for a PDCCH reception on the first PDCCH candidate” comprises: the third TCI state indicates QCL type; “a fourth TCI state indicates QCL information of a DMRS antenna port for a PDCCH reception on the second PDCCH candidate” comprises: the fourth TCI state indicates QCL type.

In one embodiment, “a third TCI state indicates QCL information of a DMRS antenna port for a PDCCH reception on the first PDCCH candidate” comprises: the third TCI state indicates at least first two of RS resources that provide QCL information, QCL type, a serving cell configured with RS resources that provide QCL information, and a BWP where RS resources that provide QCL information are located; “a fourth TCI state indicates QCL information of a DMRS antenna port for a PDCCH reception on the second PDCCH candidate” comprises: the fourth TCI state indicates at least first two of RS resources that provide QCL information, QCL type, a serving cell configured with RS resources that provide QCL information, and a BWP where RS resources that provide QCL information are located.

In one embodiment, “a third TCI state indicates QCL information of a DMRS antenna port for a PDCCH reception on the first PDCCH candidate” comprises: the third TCI state indicates RS resources that provide QCL information, QCL type, a serving cell configured with RS resources that provide QCL information, and a BWP where RS resources that provide QCL information are located; “a fourth TCI state indicates QCL information of a DMRS antenna port for a PDCCH reception on the second PDCCH candidate” comprises: the fourth TCI state indicates RS resources that provide QCL information, QCL type, a serving cell configured with RS resources that provide QCL information, and a BWP where RS resources that provide QCL information are located.

In one embodiment, “the third TCI state indicates RS resources that provide QCL information” refers to: the third TCI state indicates RS resources that provide QCL information of a DMRS antenna port for a PDCCH reception on the first PDCCH candidate.

In one embodiment, “the third TCI state indicates RS resources that provide QCL information” refers to: the third TCI state indicates RS resources quasi co-located with a DMRS antenna port for a PDCCH reception on the first PDCCH candidate.

In one embodiment, “the fourth TCI state indicates RS resources that provide QCL information” refers to: the fourth TCI state indicates RS resources that provide QCL information of a DMRS antenna port for a PDCCH reception on the second PDCCH candidate.

In one embodiment, “the fourth TCI state indicates RS resources that provide QCL information” refers to: the fourth TCI state indicates RS resources quasi co-located with a DMRS antenna port for a PDCCH reception on the second PDCCH candidate.

In one embodiment, “the third TCI state indicating QCL type” refers to: the third TCI state indicates a QCL type between RS resources that provide QCL information indicated by the third TCI state and a DMRS antenna port for a PDCCH reception on the first PDCCH candidate.

In one embodiment, “the third TCI state indicating QCL type” refers to: the third TCI state indicates a QCL type corresponding to RS resources that provide QCL information indicated by the third TCI state.

In one embodiment, “the third TCI state indicating QCL type” refers to: the third TCI state indicates a QCL type configured for RS resources that provide QCL information indicated by the third TCI state.

In one embodiment, “the fourth TCI state indicating QCL type” refers to: the fourth TCI state indicates a QCL type between RS resources that provide QCL information indicated by the fourth TCI state and a DMRS antenna port for a PDCCH reception on the second PDCCH candidate.

In one embodiment, “the fourth TCI state indicating QCL type” refers to: the fourth TCI state indicates a QCL type corresponding to RS resources that provide QCL information indicated by the fourth TCI state.

In one embodiment, “the fourth TCI state indicating QCL type” refers to: the fourth TCI state indicates a QCL type configured for RS resources that provide QCL information indicated by the fourth TCI state.

In one embodiment, the QCL type comprises: TypeA, TypeB, TypeC, TypeD.

In one embodiment, QCL type indicated by the first TCI state is one of TypeA, TypeB, TypeC, or TypeD.

In one embodiment, QCL type indicated by the first TCI state is TypeA.

In one embodiment, QCL type indicated by the first TCI state is TypeD.

In one embodiment, QCL type indicated by the second TCI state is one of TypeA, TypeB, TypeC, or TypeD.

In one embodiment, QCL type indicated by the second TCI state is TypeA.

In one embodiment, QCL type indicated by the second TCI state is TypeD.

In one embodiment, QCL type indicated by the third TCI state is one of TypeA, TypeB, TypeC, or TypeD.

In one embodiment, QCL type indicated by the third TCI state is TypeA.

In one embodiment, QCL type indicated by the third TCI state is TypeD.

In one embodiment, QCL type indicated by the fourth TCI state is one of TypeA, TypeB, TypeC, or TypeD.

In one embodiment, QCL type indicated by the fourth TCI state is TypeA.

In one embodiment, QCL type indicated by the fourth TCI state is TypeD.

In one embodiment, one QCL type comprises at least one QCL parameter.

In one embodiment, QCL parameters comprised in QCL type of “TypeA” comprises: Doppler shift, Doppler spread, average delay, delay spread.

In one embodiment, QCL parameters comprised in QCL type of “TypeB” comprises: Doppler shift, Doppler spread.

In one embodiment, QCL parameters comprised in QCL type of “TypeC” comprises: Doppler shift, average delay;

In one embodiment, QCL parameters comprised in QCL type of “TypeD” comprises: Spatial Rx parameters.

In one embodiment, the meaning of “quasi co-location” comprises: large-scale properties of a channel through which a symbol on an antenna port is transmitted can be inferred from large-scale properties of a channel through which a symbol on another antenna port is transmitted.

In one embodiment, the large-scale properties comprise one or more of delay extension, average delay, Doppler extension, Doppler frequency shift, spatial reception parameters, and average gain.

In one embodiment, the large-scale properties comprise one or more of delay extension, average delay, Doppler extension, Doppler frequency shift and spatial reception parameters.

In one embodiment, the large-scale properties comprise delay extension, average delay, Doppler extension, Doppler frequency shift and spatial reception parameters.

In one embodiment, the antenna port comprises an RS port.

In one embodiment, the antenna port comprises a DMRS port.

In one embodiment, the antenna port comprises a CSI-RS port.

In one embodiment, the antenna port comprises an SRS port.

In one embodiment, the meaning of “quasi co-location” comprises: having at least one identical QCL parameter.

In one embodiment, the meaning of “quasi co-location” comprises: having identical QCL parameters.

In one embodiment, the meaning of “quasi co-location” comprises: QCL parameters with a same type as TypeD.

In one embodiment, the meaning of “quasi co-location” comprises: having identical spatial reception parameters.

In one embodiment, “a DMRS antenna port for a PDCCH reception on the first PDSCCH candidate and a first RS resource are quasi co-located” comprises: a DMRS antenna port for a PDCCH reception on the first PDSCCH candidate and a port of the first RS resource are quasi co-located; “a DMRS antenna port for a PDCCH reception on the second PDSCCH candidate and a second RS resource are quasi co-located” comprises: a DMRS antenna port for a PDCCH reception on the second PDSCCH candidate and a port of the second RS resource are quasi co-located.

In one embodiment, “a DMRS antenna port for a PDCCH reception on the first PDSCCH candidate and a first RS resource are quasi co-located” comprises: large-scale properties of a channel through which a symbol on a DMRS antenna port for a PDCCH reception on the first PDCCH candidate is transmitted can be inferred from large-scale properties of a channel through which a symbol on a port of the first RS resource is transmitted; “a DMRS antenna port for a PDCCH reception on the second PDSCCH candidate and a second RS resource are quasi co-located” comprises: large-scale properties of a channel through which a symbol on a DMRS antenna port for a PDCCH reception on the second PDCCH candidate is transmitted can be inferred from large-scale properties of a channel through which a symbol on a port of the second RS resource is transmitted.

In one embodiment, “a DMRS antenna port for a PDCCH reception on the first PDSCCH candidate and a first RS resource are quasi co-located” comprises: a DMRS antenna port for a PDCCH reception on the first PDSCCH candidate and a port of the first RS resource have at least one identical QCL parameter; “a DMRS antenna port for a PDCCH reception on the second PDSCCH candidate and a second RS resource are quasi co-located” comprises: a DMRS antenna port for a PDCCH reception on the second PDSCCH candidate and a port of the second RS resource have at least one identical QCL parameter.

In one embodiment, “a DMRS antenna port for a PDCCH reception on the first PDSCCH candidate and a first RS resource are quasi co-located” comprises: a DMRS antenna port for a PDCCH reception on the first PDSCCH candidate and a port of the first RS resource have identical QCL parameters; “a DMRS antenna port for a PDCCH reception on the second PDSCCH candidate and a second RS resource are quasi co-located” comprises: a DMRS antenna port for a PDCCH reception on the second PDSCCH candidate and a port of the second RS resource have identical QCL parameters.

In one embodiment, “a DMRS antenna port for a PDCCH reception on the first PDSCCH candidate and a first RS resource are quasi co-located” comprises: a DMRS antenna port for a PDCCH reception on the first PDSCCH candidate and a port of the first RS resource have identical QCL parameters with type of TypeD; “a DMRS antenna port for a PDCCH reception on the second PDSCCH candidate and a second RS resource are quasi co-located” comprises: a DMRS antenna port for a PDCCH reception on the second PDSCCH candidate and a port of the second RS resource have identical QCL parameters with type of TypeD.

In one embodiment, “a DMRS antenna port for a PDCCH reception on the first PDSCCH candidate and a first RS resource are quasi co-located” comprises: a DMRS antenna port for a PDCCH reception on the first PDSCCH candidate and a port of the first RS resource have identical spatial reception parameters; “a DMRS antenna port for a PDCCH reception on the second PDSCCH candidate and a second RS resource are quasi co-located” comprises: a DMRS antenna port for a PDCCH reception on the second PDSCCH candidate and a port of the second RS resource have identical spatial reception parameters.

In one embodiment, “a DMRS antenna port for a PDCCH reception on the first PDSCCH candidate and a third RS resource are quasi co-located” comprises: a DMRS antenna port for a PDCCH reception on the first PDSCCH candidate and a port of the third RS resource are quasi co-located; “a DMRS antenna port for a PDCCH reception on the second PDSCCH candidate and a fourth RS resource are quasi co-located” comprises: a DMRS antenna port for a PDCCH reception on the second PDSCCH candidate and a port of the fourth RS resource are quasi co-located.

In one embodiment, “a DMRS antenna port for a PDCCH reception on the first PDSCCH candidate and a first RS resource are quasi co-located” comprises: large-scale properties of a channel through which a symbol on a DMRS antenna port for a PDCCH reception on the first PDCCH candidate is transmitted can be inferred from large-scale properties of a channel through which a symbol on a port of the third RS resource is transmitted; “a DMRS antenna port for a PDCCH reception on the second PDSCCH candidate and a fourth RS resource are quasi co-located” comprises: large-scale properties of a channel through which a symbol on a DMRS antenna port for a PDCCH reception on the second PDCCH candidate is transmitted can be inferred from large-scale properties of a channel through which a symbol on a port of the fourth RS resource is transmitted.

In one embodiment, “a DMRS antenna port for a PDCCH reception on the first PDSCCH candidate and a third RS resource are quasi co-located” comprises: a DMRS antenna port for a PDCCH reception on the first PDSCCH candidate and a port of the third RS resource have at least one identical QCL parameter; “a DMRS antenna port for a PDCCH reception on the second PDSCCH candidate and a fourth RS resource are quasi co-located” comprises: a DMRS antenna port for a PDCCH reception on the second PDCCH candidate and a port of the fourth RS resource have at least one identical QCL parameter.

In one embodiment, “a DMRS antenna port for a PDCCH reception on the first PDSCCH candidate and a third RS resource are quasi co-located” comprises: a DMRS antenna port for a PDCCH reception on the first PDSCCH candidate and a port of the third RS resource have identical QCL parameters; “a DMRS antenna port for a PDCCH reception on the second PDSCCH candidate and a fourth RS resource are quasi co-located” comprises: a DMRS antenna port for a PDCCH reception on the second PDSCCH candidate and a port of the fourth RS resource have identical QCL parameters.

In one embodiment, “a DMRS antenna port for a PDCCH reception on the first PDSCCH candidate and a third RS resource are quasi co-located” comprises: a DMRS antenna port for a PDCCH reception on the first PDSCCH candidate and a port of the third RS resource have identical QCL parameters with type of TypeD; “a DMRS antenna port for a PDCCH reception on the second PDSCCH candidate and a fourth RS resource are quasi co-located” comprises: a DMRS antenna port for a PDCCH reception on the second PDSCCH candidate and a port of the fourth RS resource have identical QCL parameters with type of TypeD.

In one embodiment, “a DMRS antenna port for a PDCCH reception on the first PDSCCH candidate and a third RS resource are quasi co-located” comprises: a DMRS antenna port for a PDCCH reception on the first PDSCCH candidate and a port of the third RS resource have identical spatial reception parameters; “a DMRS antenna port for a PDCCH reception on the second PDSCCH candidate and a fourth RS resource are quasi co-located” comprises: a DMRS antenna port for a PDCCH reception on the second PDSCCH candidate and a port of the fourth RS resource have identical spatial reception parameters.

In one embodiment, the first TCI state indicates the first RS resource.

In one embodiment, the second TCI state indicates the second RS resource.

In one embodiment, the third TCI state indicates the third RS resource.

In one embodiment, the fourth TCI state indicates the fourth RS resource.

In one embodiment, an RS resource configured with QCL type “TypeD” indicated by the first TCI state is the first RS resource.

In one embodiment, an RS resource configured with QCL type “TypeD” indicated by the second TCI state is the second RS resource.

In one embodiment, an RS resource configured with QCL type “TypeD” indicated by the third TCI state is the third RS resource.

In one embodiment, an RS resource configured with QCL type “TypeD” indicated by the fourth TCI state is the fourth RS resource.

In one embodiment, the first RS resource is an RS resource providing QCL information.

In one embodiment, the second RS resource is an RS resource providing QCL information.

In one embodiment, the third RS resource is an RS resource providing QCL information.

In one embodiment, the fourth RS resource is an RS resource providing QCL information.

In one embodiment, the first RS resource is an RS resource that provides QCL information of a DMRS antenna port for a PDCCH reception on a first PDCCH candidate.

In one embodiment, the second RS resource is an RS resource that provides QCL information of a DMRS antenna port for a PDCCH reception on a second PDCCH candidate.

In one embodiment, the third RS resource is an RS resource that provides QCL information of a DMRS antenna port for a PDCCH reception on a first PDCCH candidate.

In one embodiment, the fourth RS resource is an RS resource that provides QCL information of a DMRS antenna port for a PDCCH reception on a second PDCCH candidate.

In one embodiment, the first TCI state indicates a QCL type corresponding to the first RS resource.

In one embodiment, the second TCI state indicates a QCL type corresponding to the second RS resource.

In one embodiment, the third TCI state indicates a QCL type corresponding to the third RS resource.

In one embodiment, the fourth TCI state indicates a QCL type corresponding to the fourth RS resource.

In one embodiment, the first TCI state indicates that a QCL type corresponding to the first RS resource comprises TypeD.

In one embodiment, the second TCI state indicates that a QCL type corresponding to the second RS resource comprises TypeD.

In one embodiment, the third TCI state indicates that a QCL type corresponding to the third RS resource comprises TypeD.

In one embodiment, the fourth TCI state indicates that a QCL type corresponding to the fourth RS resource comprises TypeD.

In one embodiment, the first RS resource comprises a downlink RS.

In one embodiment, the second RS resource comprises a downlink RS.

In one embodiment, the third RS resource comprises a downlink RS.

In one embodiment, the fourth RS resource comprises a downlink RS.

In one embodiment, the first RS resource comprises a CSI-RS resource.

In one embodiment, the second RS resource comprises a CSI-RS resource.

In one embodiment, the third RS resource comprises a CSI-RS resource.

In one embodiment, the fourth RS resource comprises a CSI-RS resource.

In one embodiment, the first RS resource comprises SS/PBCH (Synchronization Signal/Physical Broadcast Channel) block resources.

In one embodiment, the second RS resource comprises SS/PBCH (Synchronization Signal/Physical Broadcast Channel) block resources.

In one embodiment, the third RS resource comprises SS/PBCH (Synchronization Signal/Physical Broadcast Channel) block resources.

In one embodiment, the fourth RS resource comprises SS/PBCH (Synchronization Signal/Physical Broadcast Channel) block resources.

In one embodiment, the first RS resource is a CSI-RS resource or an SS/PBCH block resource.

In one embodiment, the second RS resource is a CSI-RS resource or an SS/PBCH block resource.

In one embodiment, the third RS resource is a CSI-RS resource or an SS/PBCH block resource.

In one embodiment, the fourth RS resource is a CSI-RS resource or an SS/PBCH block resource.

### Embodiment 7

Embodiment 7 illustrates a schematic diagram of a target time-domain resource set and a reference time-domain resource set according to one embodiment of the present application, as shown in FIG. 7.

In embodiment 7, a first CORESET is associated with the first search space set, and a second CORESET is associated with the second search space set; a target time-domain resource set comprises time-domain resources outside the reference time-domain resource set; in the target time-domain resource set, a DMRS antenna port for a PDCCH reception in the first CORESET and a first RS resource are quasi co-located, and a DMRS antenna port for a PDCCH reception in the second CORESET and a second RS resource are quasi co-located; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

In one embodiment, “a first CORESET being associated with the first search space set” comprises: configuration information of the first search space set comprises an index of the first CORESET.

In one embodiment, “a first CORESET being associated with the first search space set” comprises: the first search space set is a search space set configured with an index of the first CORESET.

In one embodiment, “a first CORESET being associated with the first search space set” comprises: the first CORESET is used to determine time-frequency resources occupied by a PDCCH monitoring occasion in the first search space set.

In one embodiment, “a first CORESET being associated with the first search space set” comprises: the first CORESET comprises time-frequency resources occupied by a PDCCH monitoring occasion in the first search space set.

In one embodiment, “a first CORESET being associated with the first search space set” comprises: an RE (Resource Element) occupied by the first CORESET comprises an RE occupied by a PDCCH monitoring occasion in the first search space set.

In one embodiment, “a first CORESET being associated with the first search space set” comprises: an RB occupied by the first CORESET in frequency domain comprises an RB occupied by a PDCCH monitoring occasion in the first search space set.

In one embodiment, “a first CORESET being associated with the first search space set” comprises: frequency-domain resources occupied by the first CORESET comprise frequency-domain resources occupied by a PDCCH monitoring occasion in the first search space set.

In one embodiment, “a first CORESET being associated with the first search space set” comprises: a symbol occupied by the first CORESET is used to determine a symbol occupied by a PDCCH monitoring occasion in the first search space set.

In one embodiment, “a first CORESET being associated with the first search space set” comprises: a symbol occupied by the first CORESET comprises a symbol occupied by a PDCCH monitoring occasion in the first search space set.

In one embodiment, “a second CORESET being associated with the second search space set” comprises: configuration information of the second search space set comprises an index of the second CORESET.

In one embodiment, “a second CORESET being associated with the second search space set” comprises: the second search space set is a search space set configured with an index of the second CORESET.

In one embodiment, “a second CORESET being associated with the second search space set” comprises: the second CORESET is used to determine time-frequency resources occupied by a PDCCH monitoring occasion in the second search space set.

In one embodiment, “a second CORESET being associated with the second search space set” comprises: the second CORESET comprises time-frequency resources occupied by a PDCCH monitoring occasion in the second search space set.

In one embodiment, “a second CORESET being associated with the second search space set” comprises: an RE occupied by the second CORESET comprises an RE occupied by a PDCCH monitoring occasion in the second search space set.

In one embodiment, “a second CORESET being associated with the second search space set” comprises: an RB occupied by the second CORESET in frequency domain comprises an RB occupied by a PDCCH monitoring occasion in the second search space set.

In one embodiment, “a second CORESET being associated with the second search space set” comprises: frequency-domain resources occupied by the second CORESET comprise frequency-domain resources occupied by a PDCCH monitoring occasion in the second search space set.

In one embodiment, “a second CORESET being associated with the second search space set” comprises: a symbol occupied by the second CORESET is used to determine a symbol occupied by a PDCCH monitoring occasion in the second search space set.

In one embodiment, “a second CORESET being associated with the second search space set” comprises: a symbol occupied by the second CORESET comprises a symbol occupied by a PDCCH monitoring occasion in the second search space set.

In one embodiment, for the specific definition of the RE, refer to chapter 4 in 3GPP TS 38.211.

In one embodiment, a target time-domain resource set comprises time-domain resources outside the reference time-domain resource set; in the target time-domain resource set, the first TCI state indicates QCL information of a DMRS antenna port for a PDCCH reception in the first CORESET, and the second TCI state indicates QCL information of a DMRS antenna port for a PDCCH reception in the second CORESET; in the reference time-domain resource set, the third TCI state indicates QCL information of a DMRS antenna port for a PDCCH reception in the first CORESET, and the fourth TCI state indicates QCL information of a DMRS antenna port for a PDCCH reception in the second CORESET.

In one embodiment, the first TCI state indicates the first RS resource.

In one embodiment, the second TCI state indicates the second RS resource.

In one embodiment, the third TCI state indicates the third RS resource.

In one embodiment, the fourth TCI state indicates the fourth RS resource.

In one embodiment, the target time-domain resource set comprises at least one symbol outside the reference time-domain resource set.

In one embodiment, the target time-domain resource set comprises at least one slot outside the reference time-domain resource set.

In one embodiment, the target time-domain resource set comprises a part of time-domain resources outside the reference time-domain resource set.

In one embodiment, the target time-domain resource set comprises a part or all of time-domain resources outside the reference time-domain resource set.

In one embodiment, in the target time-domain resource set, the third TCI state and the fourth TCI state are deactivated; in the reference time-domain resource set, the third TCI state and the fourth TCI state are activated.

In one embodiment, in the target time-domain resource set, the first TCI state and the second TCI state are activated; in the reference time-domain resource set, the first TCI state and the second TCI state are deactivated.

In one embodiment, in the target time-domain resource set, the third RS resource and the fourth RS resource are deactivated; in the reference time-domain resource set, the third RS resource and the fourth RS resource are activated.

In one embodiment, in the target time-domain resource set, the first RS resource and the second RS resource are activated; in the reference time-domain resource set, the first RS resource and the second RS resource are deactivated.

In one embodiment, in the target time-domain resource set, partial or all antenna ports are deactivated.

In one embodiment, in the target time-domain resource set, partial or all TRPs (Transmission Receiver Points) are deactivated.

In one embodiment, in the target time-domain resource set, partial or all antenna panels are deactivated.

In one embodiment, in the target time-domain resource set, at least one serving cell of the first node is deactivated.

In one embodiment, in the reference time-domain resource set, partial or all antenna ports are deactivated.

In one embodiment, in the reference time-domain resource set, partial or all TRPs (Transmission Receiver Points) are deactivated.

In one embodiment, in the reference time-domain resource set, partial or all antenna panels are deactivated.

In one embodiment, in the reference time-domain resource set, at least one serving cell of the first node is deactivated.

In one embodiment, in the target time-domain resource set, the first node and the second node are in Network Energy Saving mode.

In one embodiment, in the target time-domain resource set, the first node and the second node are in non-network energy-saving mode.

In one embodiment, in the reference time-domain resource set, the first node and the second node are in network energy-saving mode.

In one embodiment, in the reference time-domain resource set, the first node and the second node are in non-network energy-saving mode.

In one embodiment, the meaning of the being activated comprises: non zero power.

In one embodiment, the meaning of the being activated comprises: active.

In one embodiment, the meaning of the being deactivated comprises: muted.

In one embodiment, the meaning of the being deactivated comprises: inactive.

In one embodiment, the meaning of the being deactivated comprises: zero power.

In one embodiment, the target time-domain resource set and the reference time-domain resource set respectively comprise two types of symbols.

In one embodiment, the target time-domain resource set comprises one of the two types of symbols, and the reference time-domain resource set comprises the other of the two types of symbols.

In one embodiment, the target time-domain resource set only comprises one of the two types of symbols, and the reference time-domain resource set only comprises the other of the two types of symbols.

In one embodiment, the third TCI state and the first TCI state are respectively indicated.

In one embodiment, the fourth TCI state and the second TCI state are respectively indicated.

In one embodiment, the first TCI state and the third TCI state respectively indicate QCL information of a DMRS antenna port for a PDCCH reception in the first CORESET on two types of symbols.

In one embodiment, the second TCI state and the fourth TCI state respectively indicate QCL information of a DMRS antenna port for a PDCCH reception in the second CORESET on two types of symbols.

In one embodiment, only one of the two types of symbols is used for DL (DownLink) transmission.

In one embodiment, only one of the two types of symbols supports UL (UpLink) transmission.

In one embodiment, only one of the two types of symbols supports DL transmission and UL transmission.

In one embodiment, one of the two types of symbols only supports DL transmission, and the other type of the two symbols supports DL transmission and UL transmission.

In one embodiment, the two types of symbols are configured by higher-layer parameters as DL; one of the two types of symbols only supports DL transmission, and the other type of the two symbols supports DL transmission and UL transmission.

In one embodiment, any of the two types of symbols is configured as DL or Flexible by higher-layer parameters.

In one embodiment, the two types of symbols are configured by higher-layer parameters as DL.

In one embodiment, any of the two types of symbols is configured as DL or Flexible by higher-layer parameters; the two types of symbols are SBFD symbols and non-SBFD symbols.

In one embodiment, the two types of symbols are SBFD symbols and non-SBFD symbols.

In one embodiment, the two types of symbols respectively support SBFD and non-SBFD.

In one embodiment, the non-SBFD symbol is a DL symbol.

In one embodiment, the non-SBFD symbol is a DL symbol or a Flexible symbol.

In one embodiment, types of the two types of symbols are a first type and a type other than the first type.

In one embodiment, a type other than the first type comprises DL or Flexible.

In one embodiment, a type other than the first type is DL or Flexible.

In one embodiment, types of the two types of symbols are different, and types of the two types of symbols are respectively a first type and DL.

In one embodiment, types of the two types of symbols are different.

In one embodiment, a type of one of the two types of symbols is a first type, and a type of the other one of the two types of symbol is DL.

In one embodiment, a type of one of the two types of symbols is a first type, and a type of the other one of the two types of symbol is DL or Flexible.

In one embodiment, the first type of symbol is an SBFD symbol.

In one embodiment, both types of symbols are configured as DL by higher-layer parameters, with one type of the two types of symbols being a first type and the other type of the two types of symbols being DL.

In one embodiment, both types of symbols are configured as DL or Flexible by higher-layer parameters, with one type of the two types of symbols being a first type and the other type of the two types of symbols being DL or Flexible.

In one embodiment, a first type of symbol is configured as DL by higher-layer parameters, and one or multiple subcarriers in the first type of symbol are used for UL transmission.

In one embodiment, a first type of symbol is configured as DL by higher-layer parameters, and one or multiple RBs in the first type of symbol are used for UL transmission.

In one embodiment, a first type of symbol is configured as DL by higher-layer parameters, and the first type of symbol supports UL transmission.

In one embodiment, if a symbol is configured or indicated as the first type, the symbol is used for full duplex/SBFD mode.

In one embodiment, if a symbol is configured or indicated as the first type, the symbol is used for both uplink and downlink at the same time.

In one embodiment, if a symbol is configured or indicated as the first type, the symbol is used for uplink on one part of RBs and for downlink on another part of RBs.

In one subembodiment of the above embodiment, the one part of RBs and the another part of RBs belong to a same cell.

In one subembodiment of the above embodiment, the one part of RBs and the another part of RBs belong to a same BWP.

In one embodiment, if a symbol is configured or indicated as a type different from the first type, the symbol is not used for full duplex/SBFD mode.

In one embodiment, if a symbol is configured or indicated as a type different from the first type, the symbol is only used for uplink or only for downlink.

In one embodiment, the higher-layer parameter is an RRC parameter.

In one embodiment, the higher-layer parameters comprise tdd-UL-DL-ConfigurationCommon.

In one embodiment, the higher-layer parameters comprise tdd-UL-DL-ConfigurationDedicated.

In one embodiment, the higher-layer parameters comprise tdd-UL-DL-ConfigurationCommon and tdd-UL-DL-ConfigurationDedicated.

In one embodiment, the higher-layer parameters comprise at least one of tdd-UL-DL-ConfigurationCommon or tdd-UL-DL-ConfigurationDedicated.

In one embodiment, for specific meaning of the tdd-UL-DL-ConfigurationCommon and tdd-UL-DL-ConfigurationDedicated, refer to chapter 11 in 3GPP TS38.213.

In one embodiment, the first TCI state indicates QCL information of a DMRS antenna port for a PDCCH reception in the first CORESET on a symbol of the first type; the third TCI state indicates QCL information of a DMRS antenna port for a PDCCH reception in the first CORESET on a symbol of a type other than the first type.

In one embodiment, the third TCI state indicates QCL information of a DMRS antenna port for a PDCCH reception in the first CORESET on a symbol of the first type; the first TCI state indicates QCL information of a DMRS antenna port for a PDCCH reception in the first CORESET on a symbol of a type other than the first type.

In one embodiment, the second TCI state indicates QCL information of a DMRS antenna port for a PDCCH reception in the second CORESET on a symbol of the first type; the fourth TCI state indicates QCL information of a DMRS antenna port for a PDCCH reception in the second CORESET on a symbol of a type other than the first type.

In one embodiment, the fourth TCI state indicates QCL information of a DMRS antenna port for a PDCCH reception in the second CORESET on a symbol of the first type; the second TCI state indicates QCL information of a DMRS antenna port for a PDCCH reception in the second CORESET on a symbol of a type other than the first type.

In one embodiment, the target time-domain resource set comprises a symbol of a type other than the first type, and the reference time-domain resource set comprises a symbol of the first type.

### Embodiment 8

Embodiment 8 illustrates a schematic diagram of RS resources quasi co-located with a DMRS antenna port for a PDCCH reception on a first PDCCH candidate and RS resources quasi co-located with a DMRS antenna port for a PDCCH reception on a second PDCCH candidate according to another embodiment of the present application, as shown in FIG. 8.

In embodiment 8, when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located.

In one embodiment, one of the first PDCCH candidate and the second PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, when both the first PDCCH candidate and the second PDCCH candidate are orthogonal to the reference time-domain resource set in time domain or when both the first PDCCH candidate and the second PDCCH candidate belong to the reference time-domain resource set in time domain, a first TCI state indicates QCL information of a DMRS antenna port for a PDCCH reception on the first PDCCH candidate, and a second TCI state indicates QCL information of a DMRS antenna port for a PDCCH reception on the second PDCCH candidate; when between the first PDCCH candidate and the second PDCCH candidate, one PDCCH candidate is orthogonal to the reference time-domain resource set in time domain and the other PDCCH candidate overlaps with the reference time-domain resource set, a third TCI state indicates QCL information of a DMRS antenna port for a PDCCH reception on the first PDCCH candidate, and a fourth TCI state indicates QCL information of a DMRS antenna port for a PDCCH reception on the second PDCCH candidate.

In one embodiment, when both the first PDCCH candidate and the second PDCCH candidate are orthogonal to the reference time-domain resource set in time domain, a first TCI state indicates QCL information of a DMRS antenna port for a PDCCH reception on the first PDCCH candidate, and a second TCI state indicates QCL information of a DMRS antenna port for a PDCCH reception on the second PDCCH candidate; when between the first PDCCH candidate and the second PDCCH candidate, one PDCCH candidate is orthogonal to the reference time-domain resource set in time domain and the other PDCCH candidate overlaps with the reference time-domain resource set, a third TCI state indicates QCL information of a DMRS antenna port for a PDCCH reception on the first PDCCH candidate, and a fourth TCI state indicates QCL information of a DMRS antenna port for a PDCCH reception on the second PDCCH candidate.

In one embodiment, when both the first PDCCH candidate and the second PDCCH candidate belong to the reference time-domain resource set in time domain, a first TCI state indicates QCL information of a DMRS antenna port for a PDCCH reception on the first PDCCH candidate, and a second TCI state indicates QCL information of a DMRS antenna port for a PDCCH reception on the second PDCCH candidate; when between the first PDCCH candidate and the second PDCCH candidate, one PDCCH candidate is orthogonal to the reference time-domain resource set in time domain and the other PDCCH candidate overlaps with the reference time-domain resource set, a third TCI state indicates QCL information of a DMRS antenna port for a PDCCH reception on the first PDCCH candidate, and a fourth TCI state indicates QCL information of a DMRS antenna port for a PDCCH reception on the second PDCCH candidate.

### Embodiment 9

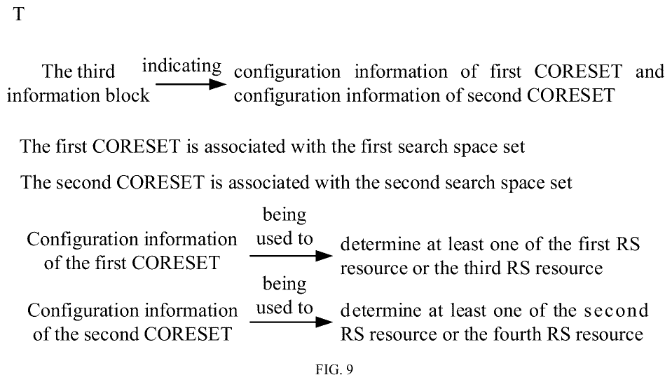

Embodiment 9 illustrates a schematic diagram of a third information block according to one embodiment of the present application, as shown in FIG. 9.

In embodiment 9, the first receiver receives a third information block; herein, the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource. In one embodiment, the third information block is carried by a higher-layer signaling.

In one embodiment, the third information block is carried by an RRC signaling.

In one embodiment, the third information block comprises all or partial fields in an RRC IE.

In one embodiment, the third information block comprises information in all or partial fields in each of multiple RRC IEs.

In one embodiment, the third information block comprises information in all or partial fields in an RRC IE whose name comprises “ControlResourceSet”.

In one embodiment, the third information block comprises information in all or partial fields in a ControlResourceSet IE.

In one embodiment, the third information block comprises information in all or partial fields in each of multiple ControlResourceSet IEs.

In one embodiment, the third information block comprises information in all or partial fields in each of two ControlResourceSet IEs.

In one embodiment, the third information block comprises a field whose name comprises “tci-StatesPDCCH” in a ControlResourceSete IE.

In one embodiment, the third information comprises a tci-StatesPDCCH-ToAddList field in a ControlResourceSet IE.

In one embodiment, the third information comprises a field whose name comprises “tci-StatesPDCCH” in each of multiple ControlResourceSet IEs.

In one embodiment, the third information block comprises a tci-StatesPDCCH-ToAddList field in each of multiple ControlResourceSet IEs.

In one embodiment, the third information comprises a field whose name comprises “tci-StatesPDCCH” in each of two ControlResourceSet IEs.

In one embodiment, the third information block comprises a tci-StatesPDCCH-ToAddList field in each of two ControlResourceSet IEs.

In one embodiment, the third information block comprises two IE ControlResourceSets, and information in a tci-StatesPDCCH-ToAddList field in one of the two ControlResourceSet IEs comprises at least one of the first TCI state or the third TCI state, and information in a tci-StatesPDCCH-ToAddList field in the other of the two IE ControlResourceSets comprises at least one of the second TCI state or the fourth TCI state.

In one embodiment, the third information block comprises one or multiple RRC IEs.

In one embodiment, the third information block comprises one or multiple ControlResourceSet IEs.

In one embodiment, the third information block comprises multiple ControlResourceSet IEs.

In one embodiment, the third information block comprises two ControlResourceSet IEs.

In one embodiment, for specific definitions of ControlResourceSet IE, tci-StatesPDCCH-ToAddList field, refer to chapter 6.3.2 in 3GPP TS 38.331.

In one embodiment, the third information block indicates configuration information of the first CORESET and configuration information of the second CORESET.

In one embodiment, the third information block comprises two RRC IEs, and the two RRC IEs respectively indicate configuration information of the first CORESET and configuration information of the second CORESET.

In one embodiment, the third information block comprises two ControlResourceSet IEs, and the two ControlResourceSet IEs respectively indicate configuration information of a first CORESET and configuration information of the second CORESET.

In one embodiment, the third information block comprises two ControlResourceSet IEs, and partial or all fields in the two ControlResourceSet IEs respectively indicate configuration information of a first CORESET and configuration information of the second CORESET.

In one embodiment, configuration information of a CORESET comprises: CORESET index, DMRS scrambling sequence initialization value, frequency domain precoding granularity, number of consecutive symbols in CORESET, frequency-domain resources in CORESET, mapping parameters from CCE (Control Channel Element) to REG (Resource Element Group), QCL information of a DMRS antenna port for a PDCCH reception and an indication of the presence or absence of a TCI field used for DCI format.

In one embodiment, for configuration information of the CORESET, refer to chapter 10.1 in 3GPP TS 38.213.

In one embodiment, a controllResourceSetId field in a ControlResourceSet IE comprised in the third information block indicates a CORESET index.

In one embodiment, a pdcch-DMRS-ScramblingID field in a ControlResourceSet IE comprised in the third information block indicates an initialization value of a DMRS scrambling sequence.

In one embodiment, a precoderGranularity field in a ControlResourceSet IE comprised in the third information block indicates frequency-domain precoder granularity.

In one embodiment, a duration field in a ControlResourceSet IE comprised in the third information block indicates a number of consecutive symbols in CORESET.

In one embodiment, a frequency DomainResources field in a ControlResourceSet IE comprised in the third information block indicates frequency-domain resources of CORESET.

In one embodiment, a cce-REG-MappingType field in a ControlResourceSet IE comprised in the third information block indicates mapping parameters from CCE to REG.

In one embodiment, a tci-StatesPDCCH-ToAddList field in a ControlResourceSet IE comprised in the third information block indicates QCL information of a DMRS antenna port for a PDCCH reception.

In one embodiment, a tci-PresentInDCI field or a tci-PresentDCI-1-2 field in a ControlResourceSet IE comprised in the third information block indicates an indication of a presence or absence of a TCI field for use in a DCI format.

In one embodiment, configuration information of the first CORESET comprises part or all of configuration information of the CORESET.

In one embodiment, configuration information of the first CORESET at least comprises a CORESET index in configuration information of the CORESET.

In one embodiment, configuration information of the first CORESET at least comprises a CORESET index in configuration information of the CORESET, frequency-domain precoder granularity, a number of consecutive symbols in CORESET, and frequency-domain resources in CORESET. In one embodiment, configuration information of the first CORESET at least comprises QCL information of a DMRS antenna port for a PDCCH reception in configuration information of the CORESET.

In one embodiment, configuration information of the first CORESET at least comprises a CORESET index in configuration information of the CORESET and QCL information of a DMRS antenna port for a PDCCH reception.

In one embodiment, configuration information of the first CORESET at least comprises a CORESET index in configuration information of the CORESET, frequency-domain precoder granularity, a number of consecutive symbols in CORESET, frequency-domain resources in CORESET, and QCL information of a DMRS antenna port for a PDCCH reception.

In one embodiment, configuration information of the second CORESET comprises part or all of the configuration information of the CORESET.

In one embodiment, configuration information of the second CORESET at least comprises a CORESET index in configuration information of the CORESET.

In one embodiment, configuration information of the second CORESET at least comprises a CORESET index in configuration information of the CORESET, frequency-domain precoder granularity, a number of consecutive symbols in CORESET, and frequency-domain resources in CORESET.

In one embodiment, configuration information of the second CORESET at least comprises QCL information of a DMRS antenna port for a PDCCH reception in configuration information of the CORESET.

In one embodiment, configuration information of the second CORESET at least comprises a CORESET index in configuration information of the CORESET and QCL information of a DMRS antenna port for a PDCCH reception.

In one embodiment, configuration information of the second CORESET at least comprises a CORESET index in configuration information of the CORESET, frequency-domain precoder granularity, a number of consecutive symbols in CORESET, frequency-domain resources in CORESET, and QCL information of a DMRS antenna port for a PDCCH reception.

In one embodiment, configuration information of the first CORESET indicates at least one of the first RS resource or the third RS resource, and configuration information of the second CORESET indicates at least one of the second RS resource or the fourth RS resource.

In one embodiment, configuration information of the first CORESET indicates the first RS resource and the third RS resource, and configuration information of the second CORESET indicates the second RS resource and the fourth RS resource.

In one embodiment, configuration information of the first CORESET indicates an index of the first RS resource and an index of the third RS resource, and configuration information of the second CORESET indicates an index of the second RS resource and an index of the fourth RS resource.

In one embodiment, configuration information of the first CORESET comprises at least one of the first TCI state or the third TCI state, and configuration information of the second CORESET comprises at least one of the second TCI state or the fourth TCI state.

In one embodiment, configuration information of the first CORESET comprises the first TCI state and the third TCI state, and configuration information of the second CORESET comprises the second TCI state and the fourth TCI state.

In one embodiment, the first CORESET and the second CORESET are both configured with two TCI states.

In one embodiment, configuration information of the first CORESET comprises at least a first TCI state in the first TCI state or an index of the third RS resource, and configuration information of the second CORESET comprises at least a second TCI state in the second TCI state or an index of the fourth RS resource.

In one embodiment, at least one of the first CORESET or second CORESET is configured with two TCI states.

In one embodiment, the first CORESET is configured with two TCI states, and the two TCI states comprise the first TCI state and the third TCI state.

In one embodiment, the second CORESET is configured with two TCI states, and the two TCI states comprise the second TCI state and the fourth TCI state.

In one embodiment, configuration information of the first CORESET comprises the first TCI state and the third TCI state, where the first TCI state indicates the first RS resource and the third TCI state indicates the third RS resource.

In one embodiment, configuration information of the first CORESET comprises the first TCI state and the third TCI state, where the first TCI state indicates an index of the first RS resource and the third TCI state indicates an index of the third RS resource.

In one embodiment, configuration information of the second CORESET comprises the second TCI state and the fourth TCI state, the second TCI state indicates the second RS resource, and the fourth TCI state indicates the fourth RS resource.

In one embodiment, configuration information of the second CORESET comprises the second TCI state and the fourth TCI state, the second TCI state indicates an index of the second RS resource, and the fourth TCI state indicates an index of the fourth RS resource.

### Embodiments 10A-10B

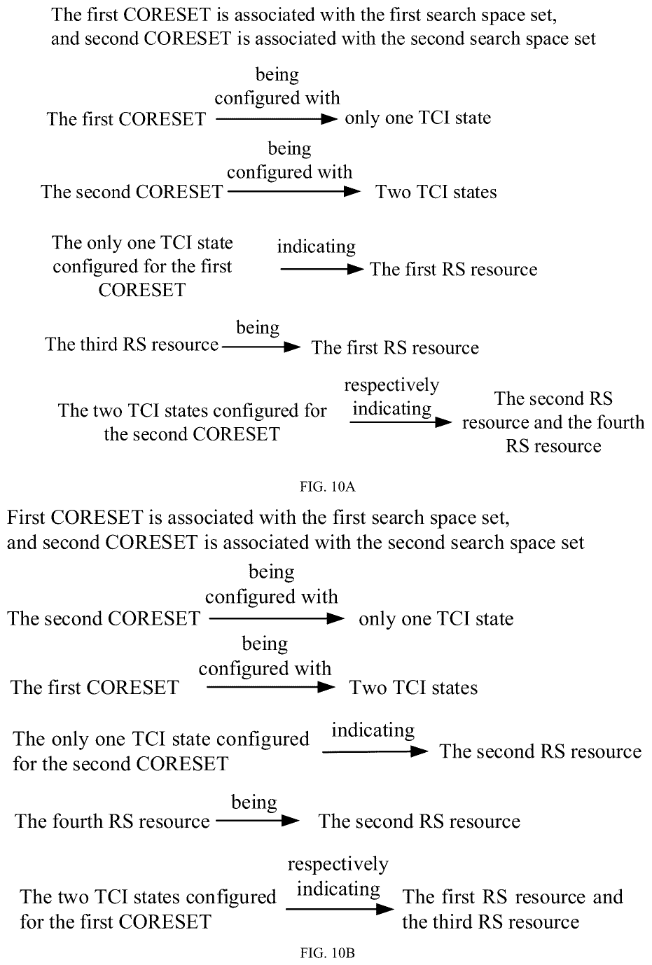

Embodiments 10A-10B respectively illustrate schematic diagrams of a first CORESET being configured with only one TCI state or a second CORESET being configured with only one TCI state according to one embodiment of the present application, as shown in FIGS. 10A-10B.

In embodiment 10A, a first CORESET is associated with the first search space set, and a second CORESET is associated with the second search space set; the first CORESET is configured with only one TCI state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource.

In one embodiment, the first CORESET is configured with only one TCI state, and the only one TCI state configured to the first CORESET is the first TCI state.

In one embodiment, the first CORESET is configured with only the first TCI state in the first TCI state and the third TCI state.

In one embodiment, the first CORESET is configured with only the first TCI state, and the third TCI state is the first TCI state.

In one embodiment, the third TCI state indicates the third RS resource, and the third RS resource is the first RS resource.

In one embodiment, the third TCI state is the first TCI resource, and the third RS resource is the first RS resource.

In one embodiment, the first TCI state indicates the first RS resource.

In one embodiment, the first TCI state indicates an index of the first RS resource.

In one embodiment, the second CORESET is configured with two TCI states, and the two TCI states configured to the second CORESET comprise the second TCI state and the fourth TCI state.

In one embodiment, the second CORESET is configured with two TCI states, and the two TCI states configured to the second CORESET are the second TCI state and the fourth TCI state.

In one embodiment, the second CORESET is configured with the second TCI state and the fourth TCI state

In one embodiment, the second CORESET is configured with the second TCI state and the fourth TCI state, and the second TCI state and the fourth TCI state respectively indicate the second RS resource and the fourth RS resource.

In one embodiment, the second TCI state and the fourth TCI state are two different TCI states. In one embodiment, the second TCI state indicates the second RS resource.

In one embodiment, the second TCI state indicates an index of the second RS resource.

In one embodiment, the fourth TCI state indicates the fourth RS resource.

In one embodiment, the fourth TCI state indicates an index of the fourth RS resource.

In embodiment 10B, a first CORESET is associated with the first search space set, and a second CORESET is associated with the second search space set; the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

In one embodiment, the second CORESET is configured with only one TCI state, and the only one TCI state configured to the second CORESET is the second TCI state.

In one embodiment, the second CORESET is configured with only the second TCI state in the second TCI state and the fourth TCI state.

In one embodiment, the second CORESET is configured with only the second TCI state, and the fourth TCI state is the second TCI state.

In one embodiment, the fourth TCI state indicates the fourth RS resource, and the fourth RS resource is the second RS resource.

In one embodiment, the fourth TCI state is the second RS resource, and the fourth RS resource is the second RS resource.

In one embodiment, the second TCI state indicates the second RS resource.

In one embodiment, the second TCI state indicates an index of the second RS resource.

In one embodiment, the first CORESET is configured with two TCI states, and the two TCI states configured to the first CORESET comprise the first TCI state and the third TCI state.

In one embodiment, the first CORESET is configured with two TCI states, and the two TCI states configured to the first CORESET is the first TCI state and the third TCI state.

In one embodiment, the first CORESET is configured with the first TCI state and the third TCI state.

In one embodiment, the first CORESET is configured with the first TCI state and the third TCI state, and the first TCI state and the third TCI state respectively indicate the first RS resource and the third RS resource.

In one embodiment, the first TCI state and the third TCI state are two different TCI states.

In one embodiment, the first TCI state indicates the first RS resource.

In one embodiment, the first TCI state indicates an index of the first RS resource.

In one embodiment, the third TCI state indicates the third RS resource.

In one embodiment, the third TCI state indicates an index of the third RS resource.

### Embodiments 11A-11B

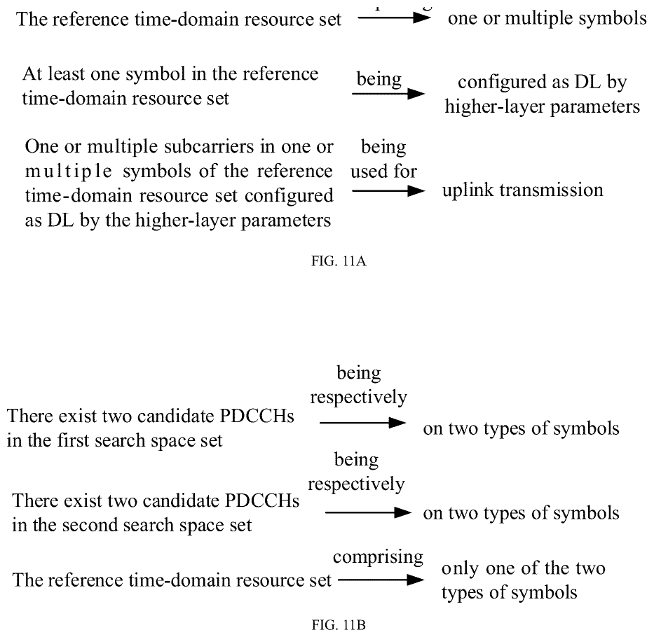

Embodiments. 11A-11B respectively illustrate schematic diagrams of a reference time-domain resource set and two types of symbols according to one embodiment of the present application, as shown in FIGS. 11A-11B.

In embodiment 11A, the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameters in the reference time-domain resource set are used for uplink transmission.

In one embodiment, one or multiple RBs in one or multiple symbols configured as DL by the higher-layer parameters in the reference time-domain resource set are used for uplink transmission.

In one embodiment, each symbol in the reference time-domain resource set is configured as DL by higher-layer parameters.

In one embodiment, each symbol in the reference time-domain resource set is configured as DL or Flexible by higher-layer parameters.

In one embodiment, at least one symbol in the reference time-domain resource set is configured as DL by a higher-layer parameter, and at least one symbol in the reference time-domain resource set is configured as Flexible by higher-layer parameters.

In one embodiment, the reference time-domain resource set is configured to a serving cell.

In one embodiment, the reference time-domain resource set is configured to at least one BWP (BandWidth Part).

In one embodiment, the reference time-domain resource set is configured to a BWP.

In one embodiment, the reference time-domain resource set is configured to a DL BWP.

In one embodiment, the higher-layer parameter is carried by an RRC signaling.

In one embodiment, the higher-layer parameters comprise all or partial fields in an RRC IE.

In one embodiment, the higher-layer parameter comprises all or partial fields in each RRC IE in multiple RRC IEs.

In one embodiment, the higher-layer parameter comprises all or partial fields in a TDD-UL-DL-ConfigCommon IE.

In one embodiment, the higher-layer parameter comprises all or partial fields in a TDD-UL-DL-ConfigDedicated IE.

In one embodiment, the higher-layer parameter comprises all or partial fields in a ServingCellConfig IE.

In one embodiment, the higher-layer parameter comprises all or partial fields in a ServingCellConfigCommonSIB IE.

In one embodiment, the higher-layer parameter comprises information in all or partial fields in a ServingCellConfigCommon IE.

In one embodiment, the higher-layer parameter is carried by at least one RRC IE.

In one embodiment, a name of an IE carrying the higher-layer parameter comprises TDD-UL-DL-Config.

In one embodiment, a name of an IE carrying the higher-layer parameter comprises ServingCellConfig.

In one embodiment, the uplink transmission in one or multiple symbols configured as DL by the higher-layer parameters in the reference time-domain resource set comprises at least one of PUSCH (Physical Uplink Shared Channel), PUCCH (Physical Uplink Control Channel), PRACH (Physical Random Access Channel), or SRS (Sounding Reference Signal).

In one embodiment, the uplink transmission in one or multiple symbols configured as DL by the higher-layer parameters in the reference time-domain resource set comprises PUSCH.

In one embodiment, the uplink transmission in one or multiple symbols configured as DL by the higher-layer parameters in the reference time-domain resource set comprises PUCCH.

In one embodiment, the uplink transmission in one or multiple symbols configured as DL by the higher-layer parameters in the reference time-domain resource set comprises PRACH.

In one embodiment, the uplink transmission in one or multiple symbols configured as DL by the higher-layer parameters in the reference time-domain resource set comprises SRS.

In one embodiment, the first receiver receives a fourth information block; herein, the fourth information block is used to determine a reference frequency-domain resource set; UL transmission in one or multiple DL symbols of the reference frequency-domain resource set belongs to the reference frequency-domain resource set in frequency domain.

In one embodiment, the fourth information block is carried by a higher-layer signaling.

In one embodiment, the fourth information block is carried by an RRC signaling.

In one embodiment, the fourth information block comprises partial or all fields in one or multiple RRC IEs.

In one embodiment, the fourth information block comprises partial fields in multiple RRC IEs.

In one embodiment, the fourth information block comprises all or partial fields in an RRC IE.

In one embodiment, the fourth information block comprises partial fields in an RRC IE.

In one embodiment, the fourth information block is carried by a MAC CE signaling.

In one embodiment, the fourth information block is carried by a physical-layer signaling.

In one embodiment, the fourth information block is carried by a DCI signaling.

In one embodiment, the fourth information block and the first information block are carried by a same RRC IE.

In one embodiment, the fourth information block and the first information block are respectively carried by two RRC IEs.

In one embodiment, the fourth information block and the first information block are received together.

In one embodiment, the reference frequency-domain resource set comprises partial or all RBs of a DL BWP.

In one embodiment, the reference frequency-domain resource set comprises partial RBs of a DL BWP.

In one embodiment, on a serving cell, UL transmission in one or multiple DL symbols of the reference frequency-domain resource set belongs to the reference frequency-domain resource set in frequency domain.

In one embodiment, on a BWP, UL transmission in one or multiple DL symbols of the reference frequency-domain resource set belongs to the reference frequency-domain resource set in frequency domain.

In one embodiment, on a DL BWP, UL transmission in one or multiple DL symbols of the reference frequency-domain resource set belongs to the reference frequency-domain resource set in frequency domain.

In one embodiment, on the serving cell where the fourth information block or the first information block is transmitted, UL transmission in one or multiple DL symbols of the reference frequency-domain resource set belongs to the reference frequency-domain resource set in frequency domain.

In one embodiment, on a BWP where the fourth information block or the first information block is transmitted, UL transmission in one or multiple DL symbols of the reference frequency-domain resource set belongs to the reference frequency-domain resource set in frequency domain.

In one embodiment, on a DL BWP where the fourth information block or the first information block is transmitted, UL transmission in one or multiple DL symbols of the reference frequency-domain resource set belongs to the reference frequency-domain resource set in frequency domain.

In one embodiment, the fourth information block is used by the first node to determine reference frequency-domain resource set.

In one embodiment, the fourth information block indicates the reference frequency-domain resource set.

In one embodiment, “the fourth information indicates the reference frequency-domain resource set” refers to: the second information block explicitly indicates the reference frequency-domain resource set.

In one embodiment, “the fourth information indicates the reference frequency-domain resource set” refers to: the second information block implicitly indicates the reference frequency-domain resource set.

In one embodiment, the third information block indicates a reference frequency-domain resource pool, and the reference frequency-domain resource set belongs to the reference frequency-domain resource pool.

In one embodiment, the fourth information block indicates the reference frequency-domain resource pool, and the reference frequency-domain resource set comprises at least one RB overlapping with a DL BWP in the reference frequency-domain resource pool.

In one embodiment, the fourth information block indicates the reference frequency-domain resource pool, and the reference frequency-domain resource set comprises all RBs overlapping with a DL BWP in the reference frequency-domain resource pool.

In one embodiment, the fourth information block indicates the reference frequency-domain resource pool, and the reference frequency-domain resource set comprises at least one RB that overlaps with a DL BWP where the fourth information block or first information block is transmitted in the reference frequency-domain resource pool.

In one embodiment, the fourth information block indicates the reference frequency-domain resource pool, and the reference frequency-domain resource set comprises all RBs that overlaps with a DL BWP where the fourth information block or first information block is transmitted in the reference frequency-domain resource pool.

In one embodiment, the reference frequency-domain resource pool comprises one or multiple RBs.

In one embodiment, the reference frequency-domain resource pool comprises consecutive multiple RBs.

In embodiment 11B, there exist two PDCCH candidates respectively on two types of symbols in the first search space set, there exist two PDCCH candidates respectively on two types of symbols in the second search space set, and the reference time-domain resource set comprises only one type of symbols between the two types of symbols.

In one embodiment, the reference time-domain resource set comprises a symbol of only first type in the two types of symbols.

In one embodiment, the reference time-domain resource set comprises one or multiple symbols of first type, and one or multiple subcarriers in one or multiple symbols of first type of the reference time-domain resource set are used for uplink transmission.

In one embodiment, the reference time-domain resource set comprises one or multiple symbols of first type, and one or multiple RBs in one or more symbols of first type of the reference time-domain resource set are used for uplink transmission.

In one embodiment, the reference time-domain resource set comprises one or multiple symbols of first type, and uplink transmission in one or multiple symbols of first type of the reference time-domain resource set belongs to the reference frequency-domain resource set in frequency domain.

### Embodiment 12

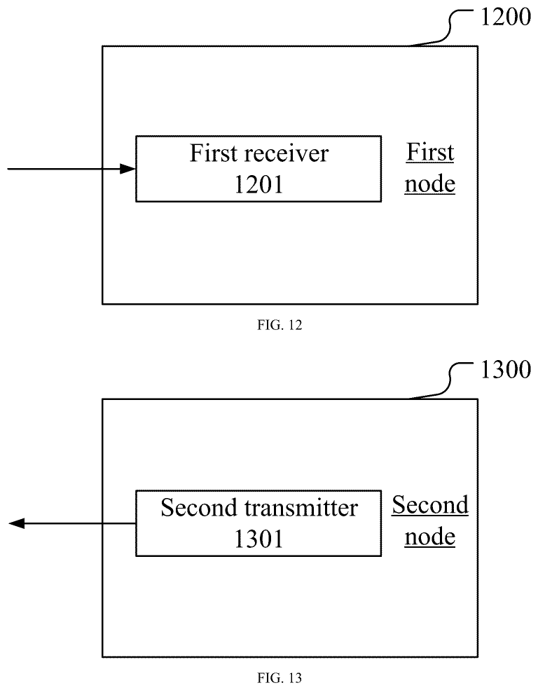

Embodiment 12 illustrates a structure block diagram of a processor in a first node according to one embodiment of the present application, as shown in FIG. 12. In FIG. 12, a processor 1200 in a first node comprises a first receiver 1201.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460, or the data source 467 in Embodiment 4.

A first receiver 1201 receives a second information block, the second information block is used to determine that a first search space set and a second search space set are linked;
the first receiver 1201 receives a first information block, the first information block is used to determine a reference time-domain resource set;

the first receiver 1201 monitors at least a first PDCCH candidate in the first search space set and at least a second PDCCH candidate in the second search space set.

In embodiment 12, the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, a first CORESET is associated with the first search space set, and a second CORESET is associated with the second search space set; a target time-domain resource set comprises time-domain resources outside the reference time-domain resource set; in the target time-domain resource set, a DMRS antenna port for a PDCCH reception in the first CORESET and a first RS resource are quasi co-located, and a DMRS antenna port for a PDCCH reception in the second CORESET and a second RS resource are quasi co-located; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

In one embodiment, when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, comprising:
the first receiver 1201 receives a third information block;
herein, the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource.

In one embodiment, a first CORESET is associated with the first search space set, and a second CORESET is associated with the second search space set; the first CORESET is configured with only one TCI state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource.

In one embodiment, a first CORESET is associated with the first search space set, and a second CORESET is associated with the second search space set; the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

In one embodiment, the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameters in the reference time-domain resource set are used for uplink transmission.

In one embodiment, there exist two PDCCH candidates respectively on two types of symbols in the first search space set, there exist two PDCCH candidates respectively on two types of symbols in the second search space set, and the reference time-domain resource set comprises only one type of symbols between the two types of symbols.

### Embodiment 13

Embodiment 13 illustrates a structure block diagram of a processor in a second node according to one embodiment of the present application, as shown in FIG. 13. In FIG. 13, a processor 1300 in a second node comprises a second transmitter 1301.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475, or the memory 476 in Embodiment 4.

A second transmitter 1301 transmits a second information block, the second information block is used to determine that a first search space set and a second search space set are linked;
a second transmitter 1301 transmits a first information block, the first information block is used to determine a reference time-domain resource set.

In embodiment 13, a receiver of the second information block monitors at least a first PDCCH candidate in the first search space set and at least a second PDCCH candidate in the second search space set; the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

In one embodiment, when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, a first CORESET is associated with the first search space set, and a second CORESET is associated with the second search space set; a target time-domain resource set comprises time-domain resources outside the reference time-domain resource set; in the target time-domain resource set, a DMRS antenna port for a PDCCH reception in the first CORESET and a first RS resource are quasi co-located, and a DMRS antenna port for a PDCCH reception in the second CORESET and a second RS resource are quasi co-located; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

In one embodiment, when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

In one embodiment, comprising:
the second transmitter 1301 transmits a third information block;
herein, the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource.

In one embodiment, a first CORESET is associated with the first search space set, and a second CORESET is associated with the second search space set; the first CORESET is configured with only one TCI state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource.

In one embodiment, a first CORESET is associated with the first search space set, and a second CORESET is associated with the second search space set; the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

In one embodiment, the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameters in the reference time-domain resource set are used for uplink transmission.

In one embodiment, there exist two PDCCH candidates respectively on two types of symbols in the first search space set, there exist two PDCCH candidates respectively on two types of symbols in the second search space set, and the reference time-domain resource set comprises only one type of symbols between the two types of symbols.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly; each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IOT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. Base stations or system equipment in the present application include, but are not limited to, macro cellular base stations, micro cellular base stations, home base stations, relay base stations, gNB (NR Node B), TRP (Transmitter Receiver Point), GNSS, relay satellites, satellite base stations, aerial base stations, RSUs (Road Side Units), drones, test equipment (e.g., transceiver units or signaling testers that simulate some of the functions of a base station), and other wireless communication equipment.

The above are merely the preferred embodiments of the present application and are not intended to limit the scope of protection of the present application. Any changes and modifications made based on the embodiments described in the specification. if similar partial or complete technical effects can be achieved, shall be deemed obvious and fall within the scope of protection of the present invention.

What is claimed is:

1. A first node for wireless communications, comprising:
a first receiver, receiving a second information block, the second information block being used to determine that a first search space set and a second search space set are linked;
the first receiver, receiving a first information block, the first information block being used to determine a reference time-domain resource set; and
the first receiver, monitoring at least a first PDCCH candidate in the first search space set and at least a second PDCCH candidate in the second search space set;
wherein the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

2. The first node according to claim 1, wherein
when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located;
or,
when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

3. The first node according to claim 1, wherein a first CORESET is associated with the first search space set, and a second CORESET is associated with the second search space set; a target time-domain resource set comprises time-domain resources outside the reference time-domain resource set; in the target time-domain resource set, a DMRS antenna port for a PDCCH reception in the first CORESET and a first RS resource are quasi co-located, and a DMRS antenna port for a PDCCH reception in the second CORESET and a second RS resource are quasi co-located; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

4. The first node according to claim 2, comprising:
the first receiver, receiving a third information block; wherein the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource;
or,
a first CORESET is associated with the first search space set, and a second CORESET is associated with the second search space set; the first CORESET is configured with only one TCI state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource; or, the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

5. The first node according to claim 1, wherein
the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameter in the reference time-domain resource set are used for uplink transmission;
or,
there exist two PDCCH candidates respectively on two types of symbols in the first search space set, there exist two PDCCH candidates respectively on two types of symbols in the second search space set, and the reference time-domain resource set comprises only one type of symbols between the two types of symbols.

6. A second node for wireless communications, comprising:
a second transmitter, transmitting a second information block, the second information block being used to determine that a first search space set and a second search space set are linked; and
the second transmitter, transmitting a first information block, the first information block being used to determine a reference time-domain resource set;
wherein a receiver of the second information block monitors at least a first PDCCH candidate in the first search space set and at least a second PDCCH candidate in the second search space set; the first PDCCH candidate and the second PDCCH candidate are monitored for detecting a DCI format with same information;
at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

7. The second node according to claim 6, wherein
when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located;
or,
when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

8. The second node according to claim 6, wherein a first CORESET is associated with the first search space set, and a second CORESET is associated with the second search space set; a target time-domain resource set comprises time-domain resources outside the reference time-domain resource set; in the target time-domain resource set, a DMRS antenna port for a PDCCH reception in the first CORESET and a first RS resource are quasi co-located, and a DMRS antenna port for a PDCCH reception in the second CORESET and a second RS resource are quasi co-located; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

9. The second node according to claim 7, wherein
comprising: the second transmitter, transmitting a third information block; wherein the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource;
or,
a first CORESET is associated with the first search space set, and a second CORESET is associated with the second search space set; the first CORESET is configured with only one TCI state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource; or, the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

10. The second node according to claim 6, wherein
the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameter in the reference time-domain resource set are used for uplink transmission;
or,
there exist two PDCCH candidates respectively on two types of symbols in the first search space set, there exist two PDCCH candidates respectively on two types of symbols in the second search space set, and the reference time-domain resource set comprises only one type of symbols between the two types of symbols.

11. A method in a first node for wireless communications, comprising:
receiving a second information block, the second information block being used to determine that a first search space set and a second search space set are linked;
receiving a first information block, the first information block being used to determine a reference time-domain resource set; and
monitoring at least a first PDCCH candidate in the first search space set and at least a second PDCCH candidate in the second search space set;
wherein the first PDCCH candidate and the second PDCCH candidate are monitored for detecting a DCI format with same information; at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

12. The method according to claim 11, wherein
when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located;
or,
when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

13. The method according to claim 11, wherein a first CORESET is associated with the first search space set, and a second CORESET is associated with the second search space set; a target time-domain resource set comprises time-domain resources outside the reference time-domain resource set; in the target time-domain resource set, a DMRS antenna port for a PDCCH reception in the first CORESET and a first RS resource are quasi co-located, and a DMRS antenna port for a PDCCH reception in the second CORESET and a second RS resource are quasi co-located; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

14. The method according to claim 12, wherein
comprising: receiving a third information block; wherein the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource;
or,
a first CORESET is associated with the first search space set, and a second CORESET is associated with the second search space set; the first CORESET is configured with only one TCI state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource; or, the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

15. The method according to claim 11, wherein
the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameter in the reference time-domain resource set are used for uplink transmission;
or,
there exist two PDCCH candidates respectively on two types of symbols in the first search space set, there exist two PDCCH candidates respectively on two types of symbols in the second search space set, and the reference time-domain resource set comprises only one type of symbols between the two types of symbols.

16. A method in a second node for wireless communications, comprising:
transmitting a second information block, the second information block being used to determine that a first search space set and a second search space set are linked; and
transmitting a first information block, the first information block being used to determine a reference time-domain resource set;
wherein a receiver of the second information block monitors at least a first PDCCH candidate in the first search space set and at least a second PDCCH candidate in the second search space set; the first PDCCH candidate and the second PDCCH candidate are monitored for detecting a DCI format with same information;
at least one of QCL information of a DMRS antenna port for a PDCCH reception on the first PDCCH candidate or QCL information of a DMRS antenna port for a PDCCH reception on the second PDCCH candidate depends on whether at least one of the first PDCCH candidate or the second PDCCH candidate overlaps with the reference time-domain resource set in time domain.

17. The method according to claim 16, comprising:
when both the first PDCCH candidate and the second PDCCH candidate are orthogonal to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when both the first PDCCH candidate and the second PDCCH candidate belong to the reference time-domain resource set in time domain, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located;
or,
when both the first PDCCH candidate and the second PDCCH candidate are orthogonal to the reference time-domain resource set in time domain, or when both the first PDCCH candidate and the second PDCCH candidate belong to the reference time-domain resource set in time domain, the DMRS antenna port for the PDCCH reception on the first PDCCH candidate and a first RS resource are quasi co-located, and the DMRS antenna port for the PDCCH reception on the second PDCCH candidate and a second RS resource are quasi co-located; when between the first PDCCH candidate and the second PDCCH candidate, one PDCCH candidate is orthogonal to the reference time-domain resource set in time domain and the other PDCCH candidate overlaps with the reference time-domain resource set, the DMRS antenna port for the PDCCH reception on the first PDCCH candidate and a third RS resource are quasi co-located, and the DMRS antenna port for the PDCCH reception on the second PDCCH candidate and a fourth RS resource are quasi co-located.

18. The method according to claim 16, wherein a first CORESET is associated with the first search space set, and a second CORESET is associated with the second search space set; a target time-domain resource set comprises time-domain resources outside the reference time-domain resource set; in the target time-domain resource set, a DMRS antenna port for a PDCCH reception in the first CORESET and a first RS resource are quasi co-located, and a DMRS antenna port for a PDCCH reception in the second CORESET and a second RS resource are quasi co-located; in the reference time-domain resource set, a DMRS antenna port for a PDCCH reception in the first CORESET and a third RS resource are quasi co-located, and a DMRS antenna port for a PDCCH reception in the second CORESET and a fourth RS resource are quasi co-located.

19. The method according to claim 17, wherein
comprising: transmitting a third information block; wherein the third information block indicates configuration information of a first CORESET and configuration information of a second CORESET; the first CORESET is associated with the first search space set, and the second CORESET is associated with the second search space set; the configuration information of the first CORESET is used to determine at least one of the first RS resource or the third RS resource, and the configuration information of the second CORESET is used to determine at least one of the second RS resource or the fourth RS resource;
or,
a first CORESET is associated with the first search space set, and a second CORESET is associated with the second search space set; the first CORESET is configured with only one TCI state, the second CORESET is configured with two TCI states, the only one TCI state configured for the first CORESET indicates the first RS resource, the third RS resource is the first RS resource, and the two TCI states configured for the second CORESET respectively indicate the second RS resource and the fourth RS resource; or, the second CORESET is configured with only one TCI state, the first CORESET is configured with two TCI states, the only one TCI state configured for the second CORESET indicates the second RS resource, the fourth RS resource is the second RS resource, and the two TCI states configured for the first CORESET respectively indicate the first RS resource and the third RS resource.

20. The method according to claim 16, wherein
the reference time-domain resource set comprises one or multiple symbols, at least one symbol in the reference time-domain resource set is configured as DL by a higher-layer parameter, and one or multiple subcarriers in one or multiple symbols configured as DL by the higher-layer parameter in the reference time-domain resource set are used for uplink transmission;
or,
there exist two PDCCH candidates respectively on two types of symbols in the first search space set, there exist two PDCCH candidates respectively on two types of symbols in the second search space set, and the reference time-domain resource set comprises only one type of symbols between the two types of symbols.
